(19) United States
(12) Patent Application Publication
(10) Pub. No.: US 2024/0419997 A1
(43) Pub. Date: Dec. 19, 2024

(54) SYSTEM AND METHOD FOR MULTI-CHIP ISING MACHINE ARCHITECTURES

(71) Applicant: University of Rochester, Rochester, NY (US)

(72) Inventors: Michael Huang, Rochester, NY (US); Anshujit Sharma, Rochester, NY (US); Richard Afoakwa, Rochester, NY (US); Zeljko Ignjatovic, Rochester, NY (US)

(21) Appl. No.: 18/712,445

(22) PCT Filed: Nov. 22, 2022
(86) PCT No.: PCT/US22/80325

§ 371 Date: May 22, 2024

Related U.S. Application Data
(60) Provisional application No. 63/281,944, filed on Nov. 22, 2021.

(51) Int. Cl. G06N 7/01

(52) U.S. Cl. CPC G06N 7/01

(57) ABSTRACT

A scalable Ising machine system comprises a plurality of chips, each chip comprising a plurality of N nodes, each node comprising a capacitor, a positive terminal, and a negative terminal, a plurality of N×M connection units, arranged in N rows and M columns, each connection unit comprising a set of reconfigurable resistive connections, each connection unit configurable to connect a pair of the N nodes via the reconfigurable resistive connections, and a plurality of interconnects, wherein each chip of the plurality of chips is communicatively connected all other chips of the plurality of chips via at least one interconnect. A method of calculating a Hamiltonian of a system of coupled spins is also disclosed.

### CROSS-REFERENCE TO RELATED APPLICATIONS

This application is a U.S. national phase application filed under 35 U.S.C. § 371 claiming benefit to International Patent Application No. PCT/US2022/080325, filed Nov. 22, 2022, which claims priority to U.S. Provisional Application No. 63/281,944, filed on Nov. 22, 2021, incorporated herein by reference in its entirety.

### STATEMENT REGARDING FEDERALLY SPONSORED RESEARCH OR DEVELOPMENT

This invention was made with government support under HR00112090012 awarded by the Defense Advanced Research Projects Agency. The government has certain rights in the invention.

### BACKGROUND OF THE INVENTION

Nature has inspired a lot of problem-solving techniques over the decades. More recently, researchers have increasingly turned to harnessing nature to solve problems directly. Ising machines are a good example and there are numerous research prototypes as well many design concepts. Ising machines can map a family of NP-complete problems and derive competitive solutions at speeds much greater than conventional algorithms and in some cases at a fraction of the energy cost of a von Neumann computer.

However, physical Ising machines are often fixed in their problem-solving capacity. Without any support, a bigger problem cannot be solved at all. The state of the art is a software-based divide-and-conquer strategy. A problem of more than N spin variables is converted into a series of sub-problems of no more than N spins then launched on a machine. As far as the Ising machine is concerned, the problems also fit the machine capacity. As discussed further herein, with this type of support the advantage of using high-performance Ising machines quickly diminishes. Degradation occurs due to fundamentals and cannot be improved via software optimization.

Disclosed herein is a machine architecture that is fundamentally scalable. In other words, each machine is capable of both acting independently to solve a simple problem or together in a group to solve a larger problem. In the latter mode, the machine explicitly recognizes external spins and implements coupling for both for intra-chip spins and inter-chip spins.

### SUMMARY OF THE INVENTION

In one aspect, a scalable Ising machine system comprises a plurality of chips, each chip comprising a plurality of N nodes, each node comprising a capacitor, a positive terminal, and a negative terminal, a plurality of N×M connection units, arranged in N rows and M columns, each connection unit comprising a set of reconfigurable resistive connections, each connection unit configurable to connect a pair of the N nodes via the reconfigurable resistive connections, and a plurality of interconnects, wherein each chip of the plurality of chips is communicatively connected all other chips of the plurality of chips via at least one interconnect.

In one embodiment, the plurality of chips is arranged in a 2-dimensional array. In one embodiment, the plurality of chips is arranged in a three-dimensional array. In one embodiment, the plurality of chips is arranged in at least one square array. In one embodiment, at least one interconnect of the plurality of interconnects comprises a wireless data connection. In one embodiment, each chip further comprises a data buffer configured to store state information of at least a subset of the N nodes digitally. In one embodiment, N=M.

In one embodiment, each connection unit comprises two positive terminals, each connected to the positive terminal of a different node in the plurality of nodes, and two negative terminals, each connected to the negative terminal of a different node of the plurality of nodes. In one embodiment, at least one interconnect of the plurality of interconnects comprises a switch configured to connect or disconnect the interconnect. In one embodiment, at least one chip further comprises a reconfigurable connection fabric for connecting the nodes. In one embodiment, each chip further comprising a buffer memory, a processor, and a non-transitory computer-readable medium with instructions stored thereon, which when executed by the processor stores node states in the buffer memory and retrieves node states from the buffer memory.

In one embodiment, the instructions further comprise the steps of sequentially transmitting node states from one chip to the next in order to execute a larger task in batch mode. In one embodiment, each buffer memory is sufficient to store a buffered copy of at least a subset of the states in the scalable Ising machine system. In one embodiment, each buffer memory is sufficient to store a buffered copy of all the states in the scalable Ising machine system.

In one aspect, a method of calculating a Hamiltonian of a system of coupled spins comprises providing a scalable Ising machine system comprising a plurality of chips, each chip comprising a plurality of N nodes, each node comprising a capacitor, a positive terminal, and a negative terminal, the charge on the capacitor representing a spin, and a plurality of N×M connection units, arranged in N rows and M columns, each connection unit comprising a set of reconfigurable resistive connections, each connection unit configurable to connect a pair of the N nodes via the reconfigurable resistive connections, connecting the plurality of chips to one another via a set of interconnects, segmenting the system of coupled spins into a set of sub-systems, and configuring each chip of the plurality of chips with a subsystem of the set of sub-systems, and calculating the Hamiltonian of the system of coupled spins by calculating all the sub-systems.

In one embodiment, the method comprises calculating the sub-systems at least partially sequentially. In one embodiment, the method comprises calculating the sub-systems simultaneously. In one embodiment, the method comprises storing states of at least a subset of the nodes in a buffer memory. In one embodiment, the method comprises transmitting a subset of node states from one chip to another. In one embodiment, the method comprises storing states of all the nodes in a buffer memory on each chip of the plurality of chips.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is an exemplary computing device.

FIG. 2A and FIG. 2B are graphs of speedup versus graph size.

FIG. 3 is a diagram of an exemplary multi-node chip.

FIG. 4 is a schematic diagram of a coupling unit.

FIG. 5A and FIG. 5B are diagrams of exemplary multi-chip architectures.

FIG. 6 is an exemplary diagram mapped to a matrix.

FIG. 7 is an exemplary multi-chip architecture.

FIG. 8 is a diagram of an exemplary reconfigurable multi-node architecture.

FIG. 9 is a diagram of an exemplary multi-chip architecture arranged in a three-dimensional array.

FIG. 10A and FIG. 10B are graphs of energy surprise over ignorance for different epoch sizes.

FIG. 11 is a diagram of an exemplary batching architecture.

FIG. 12 is a graph of execution time for various architectures.

FIG. 13 is a graph of execution time for various architectures.

FIG. 14A is a graph of flips and bit changes over execution time.

FIG. 14B is a graph of average flips and bit changes across different epoch sizes.

FIG. 15A and FIG. 15B is a graph of calculated results across execution time.

FIG. 16A is a graph of induced spin flips over execution time.

FIG. 16B is a graph of average percentage of induced spin flips over epoch time.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

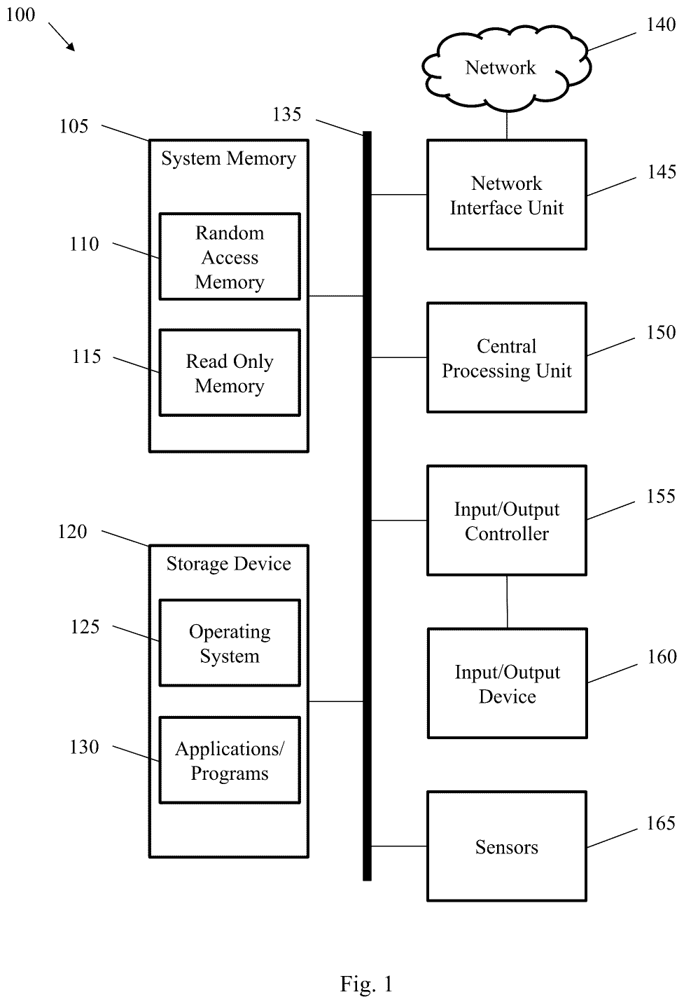

FIG. 1 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts an illustrative computer architecture for a computer 100 for practicing the various embodiments of the invention. The computer architecture shown in FIG. 1 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in some embodiments can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Described herein, in various embodiments, are a 3D-integrated multi-chip Ising machine, a macro-chip version where multiple “chiplets” integrated on a carrier, a system based on a generic digital interconnect for a number of reconfigurable Ising machines, and various optimization techniques for the interconnected Ising machines.

Examples of computing tasks performed in nature include solving differential equations, performing random sampling, and so on. Some of these natural processes have been harnessed already. Transistors, for example, can be turned on and off and are the foundation for most computers today. But this is different from harnessing nature's computational capability at some higher level, for example, to solve an entire problem. Indeed, some very powerful algorithms are inspired by nature (S. Kirkpatrick, et al., Science, vol. 220, 1983; G. Zames, et al., Information Technology Journal, 1981; and D. H. Ackley, et al., Cognitive science, 1985).

It is not hard to imagine that if a computing substrate is nature-based, certain problems could be solved much more quickly and efficiently than through mapping to a von Neumann architecture. One particular branch of this effort that has seen some recent rapid advance is Ising machines.

In a nutshell, Ising machines seek low energy states for a system of coupled spins. A number of problems (in fact, all NP-complete problems) can be expressed as an equivalent optimization problem of the Ising formula, as will be detailed further below. Though existing Ising machines are largely prototypes or concepts, they are already showing promise of better performance and energy efficiency for specific problems.

Sometimes, when the problem size is beyond the capacity of the machine, the problem can no longer be mapped to a particular hardware. Intuitively, with some form of divide and conquer, it should be possible to divide a larger problem into smaller sub-problems that can map to multiple instances of a given hardware and thus still benefit from the acceleration of an Ising machine. In one existing example, with the algorithm employed by D-Wave (M. Booth, et al, Technical Report, 2017), the effective speedup of a system employing such a divide-and-conquer strategy quickly diminishes as the size of the problem increases. As an example, while a 500-node machine can reach a speedup of 600,000 over a von Neumann solver (simulated annealing), using the same machine to solve a 520-node problem will only achieve a speedup of 250.

The present disclosure includes a discussion of the problems presented by the simple divide-and-conquer strategy. It is shown that such a strategy is fundamentally limited in its performance by “glue” computation. Thus there is a need in the art for machines that are designed from ground up to obviate such glue. Hardware designs are disclosed herein which in some embodiments may achieve this goal. Finally, experimental data is presented that shows the design can indeed scale to larger problems while maintaining high performance, achieving more than 6 orders of magnitude speedup over sequential solvers and over 2000× speedup over the state-of-the-art computational accelerators.

### Principles of Ising Machines

The Ising model is used to describe the Hamiltonian of a system of coupled spins. Each spin has one degree of freedom and takes one of two values (+1, −1). The energy of the system is a function of pair-wise coupling of the spins (Jᵢⱼ=Jⱼᵢ) and the interaction of some external field (μ) with each spin (hᵢ). The resulting Hamiltonian is as follows:

$$H = - {\sum }_{i , j} {J}_{ij} {σ}_{i} {σ}_{j} - {\sum }_{i} {h}_{i} {σ}_{i} \qquad Equation 1$$

Given such a formulation, a minimization problem can be stated: what state of the system ([σ₁, σ₂, . . . ]) has the lowest energy. A physical system with such a Hamiltonian naturally tends towards low-energy states. It is as if nature always tries to solve the minimization problem, which is not a trivial task.

Indeed, the cardinality of the state space grows exponentially with the number of spins, and the optimization problem is NP-complete: it is easily convertible to and from a generalized max-cut problem, which is part of the original list of NP-complete problems (R. M. Karp, Springer US, 1972, pp. 85-103).

Thus if a physical system of spins somehow offers programmable coupling parameters (Jᵢⱼ and μhᵢ in Equation 1), they can be used as a special purpose computer to solve optimization problems that can be expressed in Ising formula (Equation 1). In fact, all problems in the Karp NP-complete set have their Ising formula derived (A. Lucas, Frontiers in Physics, 2014). Also, if a problem already has a QUBO (quadratic unconstrained binary optimization) formulation, mapping to Ising formula is as easy as substituting bits for spins: σᵢ=2bᵢ−1.

Because of the broad class of problems that can map to the Ising formula, building nature-based computing systems that solve these problems has attracted significant attention. Loosely speaking, an Ising machine's design goes through four steps:
(1) Identify the physical variable to represent a spin, be it a qubit (R. Harris, et al., Phys. Rev. B, July 2010); the phase of an optical pulse (T. Inagaki, et al., Science, 2016); or the polarity of a capacitor (R. Afoakwa, et al., 2021 IEEE International Symposium on High-Performance Computer Architecture (HPCA), 2021).
(2) Identify the mechanism of coupling and how to program the coefficients.
(3) Demonstrate the problem solving capability showing both the theory of its operation (reveal the “invisible hand” of nature) and satisfactory results of practice.
(4) Demonstrate superior machine metrics (solution time, energy consumption, and/or construction costs).

It is important to note that different approaches may offer different fundamental tradeoffs. Thus it would be premature to evaluate a general approach based on observed instances of prototypes. Nevertheless, disclosed herein is a broad-brushed characterization, which can assist those skilled in the art to get a basic sense of the landscape as long as the caveats are properly understood. This characterization is by no means comprehensive. In particular, for conceptual clarity, the numerous designs that accelerate a von Neumann algorithm (simulated annealing or a variant) using GPU, FPGA, or an ASIC are treated not as physical Ising machines, but as accelerated simulated annealers.

Quantum annealing (QA) is different from adiabatic quantum computing (AQC) in that it relaxes the adiabaticity requirement (S. Boixo, et al., Nature physics, 2014). QA technically includes AQC as a subset, but current D-Wave systems are not adiabatic. In other words, they do not have the theoretical guarantee of reaching the ground state. Without the ground-state guarantee, the Ising physics of qubits has no other known advantages over alternatives. And it can be argued that using quantum devices to represent spin is perhaps suboptimal. First, the devices are much more sensitive to noise, necessitating cryogenic operating conditions that consume much of the 25 kW operating power. Second, it is perhaps more difficult to couple qubits than to couple other forms of spins, which explains why current machines use a local coupling network. The result is that for general graph topologies, the number of nodes needed on these locally-coupled machines grow quadratically and a nominal 2000 nodes on the D-Wave 2000q is equivalent to only about 64 effective nodes (R. Hamerly, et al., Science advances, 2019; R. Hamerly, et al., D-Wave 2000Q arXiv, 2018).

Coherent Ising machines (CIM) can be thought of a second-generation design where some of the issues are addressed. In (T. Inagaki, et al., Science, 2016), all 2000 nodes can be coupled with each other, making it apparently the most powerful physical Ising machine to date. the exemplary CIM uses special optical pulses serving as spins and therefore can operate under room temperature and consumes only about 200 W power. However, the pulses need to be contained in a 1 km-long optical fiber, and it is challenging to maintain stable operating conditions for many spins as the system requires stringent temperature stability. Efforts to scale beyond 2000 nodes have not yet been successful.

Because the operating principle of CIMs can be viewed with a Kuramoto model (Y. Takeda, et al., Quantum Science and Technology, November 2017), using other oscillators can in theory achieve a similar goal. This led to a number of electronic oscillator-based Ising machines (OIM) which can be considered as a third-generation. These systems use LC tanks for spins and (programmable) resistors as coupling units. Technically, the phase of the oscillators is equivalent to spin with two degrees of freedom, spanning an XY-plane (rather than the 1 degree of freedom of up or down in the Ising model). Consequently, an additional mechanism is needed to impose a constraint—such as Sub-Harmonic Injection Locking (SHIL) (K. Cho, et al., International conference on artificial neural networks. Springer, 2011)—to solve Ising formula problems. These electronic oscillator-based Ising machines are a major improvement over earlier designs in terms of machine metrics. To be sure, their exact power consumption and operation speed depend on the exact inductance and capacitance chosen and can thus span a range of orders of magnitude. But it is not difficult to target a desktop size implementation with around 1-10 W of power consumption—a significant improvement over cabinet-size machines with a power consumption of 200 W-25 kW. However, for on-chip integration, inductors are often a source of practical challenges. For example, they are area intensive, and have undesirable parasitics with reduced quality factor and increased phase noise, all of which pose practical challenges in maintaining frequency uniformity and phase synchronicity between thousands of on-chip oscillators. Another electronic design with a different architecture is the Bistable Resistively-coupled Ising Machine (BRIM) (R. Afoakwa, et al., 2021 IEEE International Symposium on High-Performance Computer Architecture (HPCA), 2021). Additional information about BRIM may be found in PCT Application No. PCT/US2021/070402, filed on Apr. 16, 2021, and incorporated herein by reference in its entirety.

In BRIM, the spin is implemented as a capacitor whose voltage is controlled by a feedback circuit making it bistable. The design is CMOS-compatible and because it uses voltage (as opposed to phase) to represent spin, it enables a straightforward interface to additional architectural support for computational tasks. Therefore in certain embodiments disclosed herein, a baseline substrate similar to BRIM is used. Note that the same principle herein could directly apply to all Ising machines with different amounts of glue logic.

For most (physical) Ising machines today, when the problem fits the hardware, significant speedup and energy gain can be expected compared to von Neumann computing. However, little is discussed on what happens when the problem is beyond the capacity of the machine. It is understandable to assume that the machine can still accelerate proportional to the fraction of the problem that can be mapped. As discussed further herein, the reality is that for problems beyond the capacity of the machine, little to no benefit at all is expected.

First, the approach adopted by D-Wave's system is discussed. As their systems are the only commercially available Ising machine platforms, their solution is both the state of the art and a baseline for any comparison. The details of a divide and conquer strategy are then discussed, starting with the basic principle and then the issue that the subproblems to be solved are not strictly independent of each other, making parallelization challenging.

With D-Wave's tool (M. Booth, et al., Technical Report, 2017), one can use any Ising machine to solve a problem larger than its hardware capacity. To see the performance of such a system (for the reader's convenience, the algorithm is replicated in the appendix), a model of BRIM is used as the Ising machine. Even though the general strategy should work with any Ising machine, BRIM offers a number of practical advantages for the disclosed study. First, it offers all-to-all coupling. This means that an n-node machine can map any n-node arbitrary graph. Many machines offer a large number of nominal nodes but only near-neighbor coupling (see R. Harris, et al., Phys. Rev. B, July 2010; M. Yamaoka, et al., 2015 IEEE International Solid-State Circuits Conference—(ISSCC) Digest of Technical Papers, February 2015; and T. Takemoto, et al., IEEE International Solid-State Circuits Conference, February 2019). A general graph of n nodes has O(n²) coupling parameters. Mapping such a graph therefore requires O(n²) nodes for local connection machines.

Second, as architectural support for scalable Ising machines later is explored later, the CMOS compatibility of BRIM provides significant design flexibility.

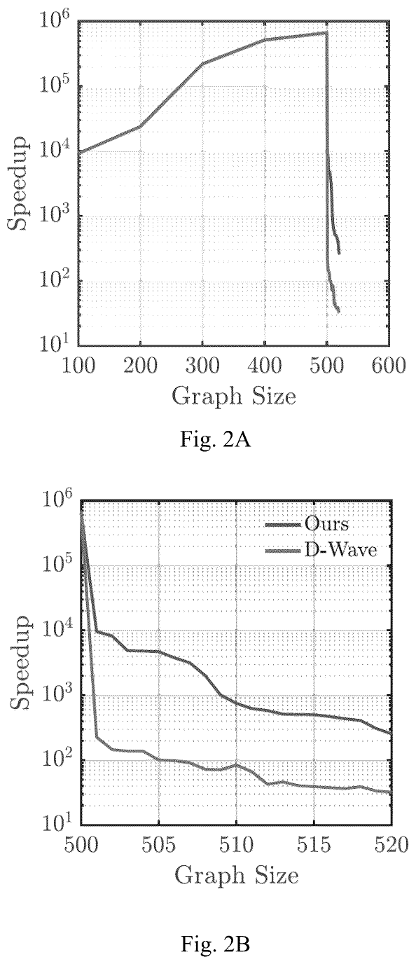

In FIG. 2A and FIG. 2B, the speedup of a 500-node Ising machine is shown as the problem size increases past the machine capacity. With reference to FIG. 2A and FIG. 2B, the speedup of two d-n-c algorithms (D-Wave and a different one as disclosed herein) using a 500-spin BRIM plus a sequential computer for support are shown. FIG. 2A shows speedup for all graphs tested. FIG. 2B is a magnified segment for graph sizes from 500 to 520.

The measurement details are ignored as they do not affect the qualitative lessons. From the figure, two things are evident. First, when the problem gets bigger but still fits within the machine, the speedup of the Ising machine increases. Clearly, larger hardware capacities are desirable. However, the figure also shows a second, and perhaps more important, point: as soon as the problem is bigger than what the hardware can hold, speedup crashes precipitously (FIG. 2B). The fact that speedup falls is not surprising. What is surprising is how much and how quickly it does. Of course, some of this is due to the specific implementation of the D-Wave tool. An alternative was therefore created, and the result (shown in FIG. 2A) is only a small improvement. The sharp drop in FIG. 2A is due to a fundamental reason, disclosed next.

Users interact with D-Wave systems using the Solver API (SAPI) over a network. A job is submitted to a SAPI server queue. Jobs are then assigned to workers, which run on a conventional processor and are responsible for submitting instructions to the quantum processor, receiving results from the quantum processor, post-processing results when necessary, and sending results back to user.

The general idea of the algorithm (see Algorithm 1, below) is straightforward: If part of the state remains fixed, then the original QUBO problem is converted into a smaller sub problem (subQubo in line 15) that can be launched on a solver (line 18). Repeating this action over different portions of the state vector (lines 15 to 21) constitutes one pass of the algorithm. Multiple passes are performed (while loop starting in line 14) to achieve a better result. Algorithm 2 below shows the disclosed, improved approach which is more efficient.

Algorithm 1 D-WAVE divide and conquer algorithm

| | |
|---|---|
| 1: | Input: QUBO instance |
| 2: | #V best, lowest value found to date |
| 3: | #Qbest, solution bit vector corresponding to the lowest value so far |
| 4: | #index, indices of the bits in the solution |
| 5: | |
| 6: | # Get initial estimate of minimum value and backbone |
| 7: | Qtmp ← random 0 / 1 vector |
| 8: | (Vbest, Qbest) ← TabuSearch(QUBO, Qtmp) |
| 9: | index ← OrderByImpact(QUBO, Qbest) |
| 10: | passCount ← 0 |
| 11: | Qtmp ← Qbest |
| 12: | total ← fraction * size(QUBO) |
| 13: | |
| 14: | while passCount < numRepeats do |
| 15: | for i = 0; i < total; i = i + subQuboSize do |
| 16: | # select subQubo with other variables clamped |
| 17: | subQubo ← Clamp(QUBO; Qtmp; index[i : |
| | i +subQuboSize − 1]) |
| 18: | (subV, subQ) ← DWaveSearch(subQubo) |
| 19: | # project onto full solution |
| 20: | Qtmp[index[i : i + subQuboSize - 1]] ← subQ |
| 21: | end for |
| 22: | (V, Qnew) ← TabuSearch(QUBO, Qtmp) |
| 23: | index ← OrderByImpact(QUBO, Qnew) |
| 24: | if V < Vbest then |
| 25: | Vbest ← V; Qbest ← Qnew |
| 26: | passCount ← 0 |
| 27: | else if V == Vbest then |
| 28: | Qbest ← Qnew |
| 29: | passCount ++ |
| 30: | else |
| 31: | passCount ++ |
| 32: | end if |
| 33: | Qtmp ← Qnew |
| 34: | end while |
| 35: | Output: Vbest, Qbest |

Algorithm 2: Alternative divide and conquer algorithm

| | |
|---|---|
| 1: | Input: Graph |
| 2: | #V ← random 0 / 1 spin vector |
| 3: | # numSolvers ← number of solvers |
| 4: | # numRepeats ← number of times to repeat |
| 5: | # epoch ← Epoch times for each solver |
| 6: | # ratio ← ratio in which the graph is to be partitioned |
| 7: | |
| 8: | (subG, subV) ← RandPartition(Graph, V, ratio) |
| 9: | ene ← IsingEnergy(subG, subV) |
| 10 | for r = 0; r < numRepeats; ++r do |
| 11: | for i = 0; i < numSolvers; ++i do |
| 12: | # Launch solvers (Can be parallel) |
| 13: | Solver(subG[i]; subV [i]; epoch[i]; ene[i]) |
| 14 | end for |
| 15: | Synchronise(subG; subV; ene) |
| 16: | end for |
| 17: | |
| 18: | V ← copy(subV) |
| 19: | FinalEne ← IsingEnergy(Graph, V ) |
| 20: | Output: V; FinalEne |

The principle of divide and conquer in Ising optimization problems is now described. The problem of minimizing Equation 1 above is often described as navigating a (high-dimensional) energy landscape to find the lowest valley. It is contemplated that one might keep some dimensions fixed (e.g., longitude) and navigate along the remaining dimensions in search of a better spot. (Many solvers can be described with this analogy.) This is the essence of the divide and conquer strategy. This point (as well as its problem) is shown clearly and explicitly below. Here, the matrix notion is more helpful. Eq. 1 may be rewritten as:

$$H = - {σ}^{T} J σ - μ {h}^{T} σ \qquad Equation 2$$

where σ=[σ₁, . . . σₙ]^{T}, J=|Jᵢⱼ|_{n×n}, and h=[h₁, . . . , hₙ]^{T}. Here/is a symmetric matrix with the diagonal being 0. If the n-node problem is divided into two sub-problems of k and n−k nodes, Equation 2 may be rewritten as follows:

$$\begin{matrix}H = [ {σ}_{u}^{T} , {σ}_{l}^{T} ] [ \begin{matrix}{J}_{u} & {J}_{x} \\ {J}_{x}^{T} & {J}_{l}\end{matrix} ] [ \begin{matrix}{σ}_{u} \\ {σ}_{l}\end{matrix} ] - μ [ {h}_{u}^{T} , {h}_{l}^{T} ] [ \begin{matrix}{σ}_{u} \\ {σ}_{l}\end{matrix} ] \\ = {σ}_{u}^{T} {J}_{u} {σ}_{u} - 2 {σ}_{l}^{T} {J}_{x}^{T} {σ}_{u} - {σ}_{l}^{T} {J}_{l} {σ}_{l} - μ ( {h}_{u}^{T} {σ}_{u} + {h}_{l}^{T} {σ}_{l} ) \\ = - ( {σ}_{u}^{T} {J}_{u} {σ}_{u} + {σ}_{l}^{T} {J}_{x}^{T} {σ}_{u} + μ {h}_{u}^{T} {σ}_{u} ) - \\ ( {σ}_{l}^{T} {J}_{l} {σ}_{l} + {σ}_{l}^{T} {J}_{x}^{T} {σ}_{l} + μ {h}_{l}^{T} {σ}_{l} ) \\ = - ( {σ}_{u}^{T} {J}_{u} {σ}_{u} + μ {g}_{u}^{T} {σ}_{u} ) - ( {σ}_{l}^{T} {J}_{l} {σ}_{l} + μ {g}_{l}^{T} {σ}_{l} )\end{matrix} \\ sub - problem ( {J}_{u} , {g}_{u} ) = - ( {σ}_{u}^{T} {J}_{u} {σ}_{u} + μ {g}_{u}^{T} {σ}_{u} ) \\ sub - problem ( {J}_{l} , {g}_{l} ) = - ( {σ}_{l}^{T} {J}_{l} {σ}_{l} + μ {g}_{l}^{T} {σ}_{l} ) \qquad Equation 3$$

where

$${g}_{u} = {h}_{u} + {J}_{x} {σ}_{l} and {g}_{l} = {h}_{l} + {J}_{x}^{T} {σ}_{u} .$$

With this rewrite, it is shown that the bigger square matrix can be decomposed into the upper and lower sub-matrices Jᵤ and Jₗ (both square), and the “cross terms” (J. and its transpose). The effect of the cross terms can be combined with the original biases (hᵤ and hᵢ respectively) into new ones (gᵤ and gₗ respectively). From this point of view, an Ising optimization problem with n nodes can always be decomposed into sub-problems of k and n-k nodes, and by transitivity into a combination of sub-problems of any sizes.

Equation 3 not only shows the principle of decomposition, it also clearly shows the issue with it. In the original problem, J and h are parameters and do not change. After decomposition, the bias of the upper partition (gᵤ) is now a function of the state of the lower partition. This means that the two partitions are not independent. In other words, strictly speaking, the sub-problems have to be solved sequentially: when search changes the current state of the upper partition, the parameters of the lower partition must be updated to reflect the change before starting the search in the lower partition. Partitioning also does not reduce total workload. It is thus not surprising that there is no parallel version of canonical simulated annealing.

In the case of trying to solve a bigger problem than a machine's capacity, the issue may seem irrelevant: After all, if a bigger problem can be decomposed into two parts (say, A and B), and A now fits into an Ising machine; one can expect to enjoy speedup from the processing of A even if processing of A and B cannot overlap. The reasoning is correct. But in reality, there are multiple subtle problems with severe consequences. Two that are relevant are discussed below:

First, as was already shown, with decomposition, the sub-problem's formulation changes constantly, which requires reprogramming. For many Ising machines, reprogramming is a costly operation and can take more time than solving the problem. To cite a perhaps extreme example, D-Wave's programming time is 11.7 ms, compared to a combined 240 μs for the rest of the steps in a typical run. Keep in mind, a common (if not universal) usage pattern of these Ising machines is to program once and anneal many (e.g., 50) times from different initial conditions and take the best result. In such a usage pattern, long programming time is amortized over many annealing runs. In a decomposed problem, reprogramming may have to occur many times within one annealing run.

Second, even if the cost of reprogramming is somehow addressed, Amdahl's law must still be considered. Using a concrete example of BRIM (FIG. 2A), the speedup of solving a 500-node problem over a sequential computer is on the order of 105. Consider using the disclosed algorithm to decompose a 510-node problem into a 500-node sub-problem mapped to the hardware and the remaining portion plus glue computation left for software. The workload for software measured in instruction amounts to about 0.13% of the software workload for the original 510-node problem. Much of the remaining software workload is the “glue” (calculating the new biases gᵤ=μhᵤ+J_{×}σₗ or and gₗ=μhₗ+J_{×}^{T}σᵤ), different from the original solver. As a result, Amdahl's law does not directly apply. Nonetheless, it is possible to estimate a speedup upper-bound on the order of 700×.

While some of the disclosed simplified analyses are meant to illustrate the crux of the issue in first principle, without the nuances, the bigger point is crystal clear and recapped below.

In principle, the problem formulation clearly allows decomposition of larger problems, but the smaller component problems are not independent. As a result, relying on von Neumann computing to glue together multiple Ising machines is a fundamentally flawed strategy, as it severely limits the acceleration of problems even marginally larger than their capacity. The machines need to be designed from the ground up to be used in collaboration and address the decomposition bottleneck.

### General Analysis of Scaling Ising Machines

The core of an Ising machine contains two types of components: nodes and coupling units. As already discussed above, the coupling units need to be programmable to accept the coupling strengths Jᵢⱼ as the input to the optimization problem, and the dynamical system will evolve based on some annealing control before the state of each individual spin are read out as the solution to the problem. The bias term μhᵢσᵢ can be viewed as a special coupling term J_{i,n+1}σᵢσₙ₊₁ (J_{i,n+1}≙μhᵢσᵢ) which coupled σᵢ with an extra, fixed spin (σₙ₊₁=+1).

Unless the problem has some specific topology, any spin can be coupled with any other spin. Thus there are far more coupling parameters (O(N²)) than spins (O(N)). A number of existing Ising machines, however, adopt a machine architecture where only nearby spins are allowed to couple, resulting in a system with O(N) coupling units and O(N) spins. A special software tool was used to first convert the original problem into a form that follows the constraint placed by the machine's architecture. Loosely speaking, these O(N) coupling units can therefore map a problem of the scale of O(\sqrt{N}). This is confirmed by observation of actual problems. The rest of the disclosure will focus only on architectures with all-to-all connections.

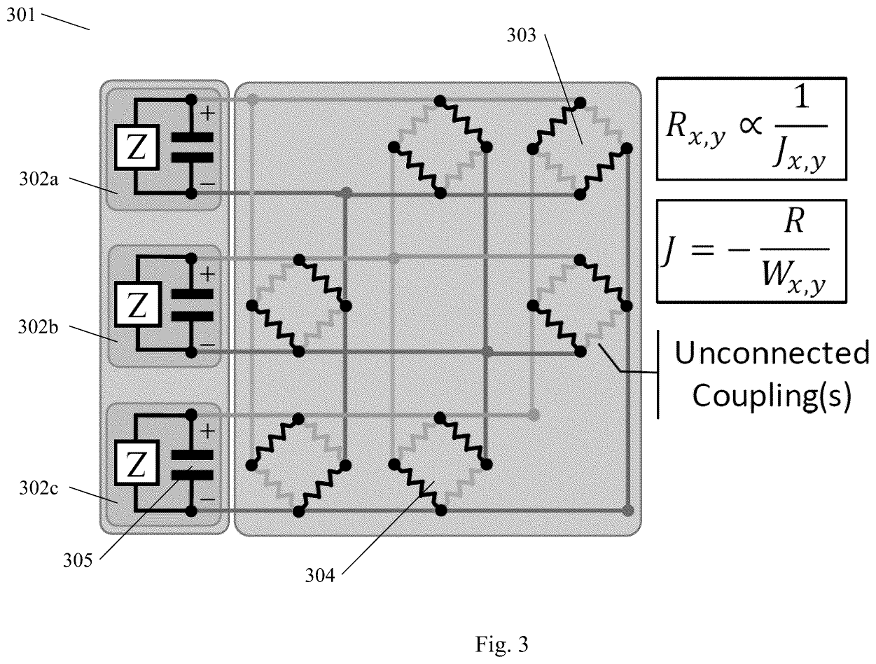

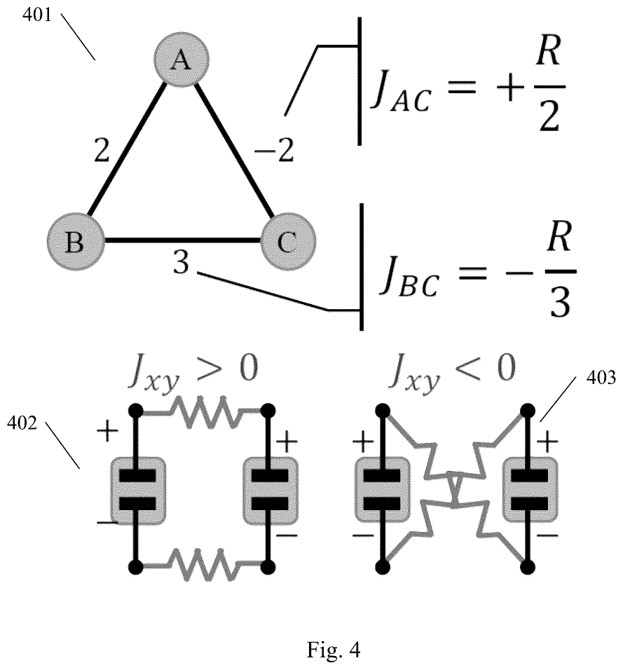

A number of electronic Ising machines have been recently proposed (T. Wang et al., 2019; T. Wang, et al., Proceedings of the 56th Annual Design Automation Conference 2019; J. Chou, et al., Scientific Reports, 2019). The primary operating principle is similar, though at a deeper level there are significant technical differences. The baseline is BRIM where an array of N bi-stable nodes are interconnected by an array of N×N resistive coupling units. With reference to FIG. 3 and FIG. 4, a block diagram of BRIM showing nodal capacitors (305, coupling resistors (303, 304), and parallel/antiparallel connections is shown. The coupling units are programmed by an array of DACs before the system starts annealing. The coupling resistor value between nodes i and j is set to 1/Jᵢⱼ: strong coupling meaning lower resistance. And the sign of coupling strength can be implemented with either parallel (303, 402) or antiparallel (304, 403) connections. Specifically, if the coupling parameter Jᵢⱼ is negative, then the two nodes are connected in an antiparallel (304) fashion (for example, the positive plate of 302a is connected to the negative plate of 302b and vice versa). This encourages the two nodes to be in opposite polarities, so that the contribution of this pair's coupling (Jᵢⱼσᵢσⱼ) lowers the overall energy. Conversely, if Jᵢⱼ is positive, the plates of the same polarity will be coupled through the resistor (for example, the positive plate of 302a is connected to the positive plate of 302c and vice-versa).

All these electronic Ising machines can be analyzed as a dynamical system and Lyapunov stability analysis shows why they tend toward low-energy states in a more theoretical fashion. But a more intuitive discussion with an example situation suffices for the purposes of this disclosure. Supposing that the system is in a particular state, and one spin (say, σₖ=1) is “wrong”—meaning if the spin is “flipped” (σₖ=+1), energy will improve/decrease. This means

$${σ}_{k} ( {\sum }_{j \neq k} {J}_{jk} {σ}_{j} ) < 0 \qquad Equation 4$$

Jⱼₖ is represented by the coupling resistor between nodes j and k and substitute σⱼ with the representation of it (Vⱼ, the voltage of node j), the term Σ_{j≠k}Jⱼₖσⱼ; is thus approximated by

$${\sum }_{j \neq k} \frac{{V}_{j}}{{R}_{jk}} ,$$

which describes the current coupling into node k. According to Equation 4, this value is of the opposite sign of σₖ. This shows that if node k is wrong, the combined current input to it will be in the opposite polarity and thus has the effect of trying to correct/flip it. A similar exercise can show that when node k is correct (i.e. flipping it would increase/deteriorate energy), the current input from outside node k will agree with the current polarity of k, thus keeping it in the current state. Given this baseline, one conceptually straightforward design of an Ising machine with a large capacity is now disclosed.

### A Macrochip Architecture

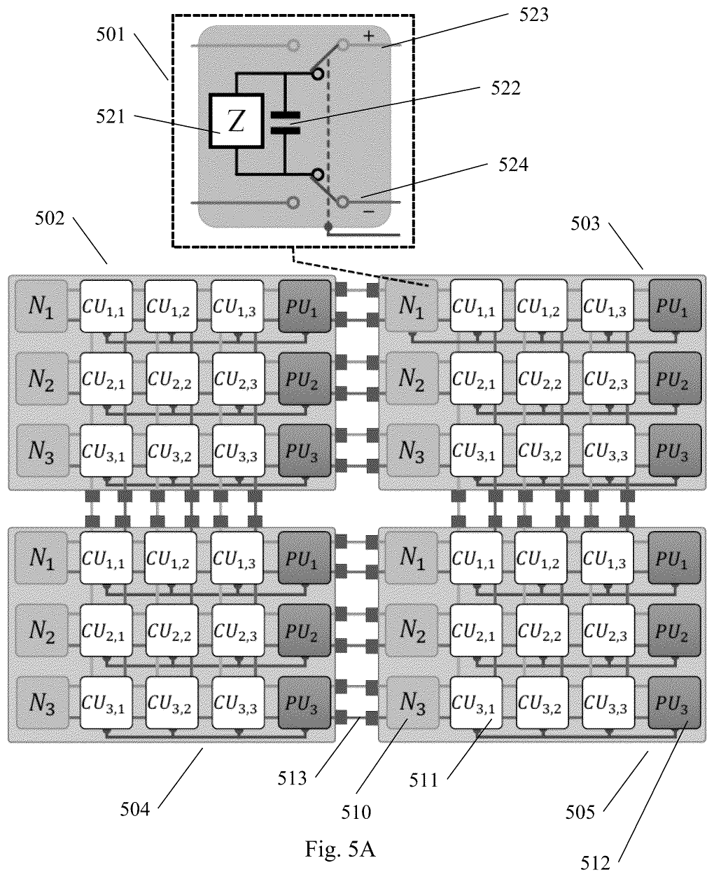

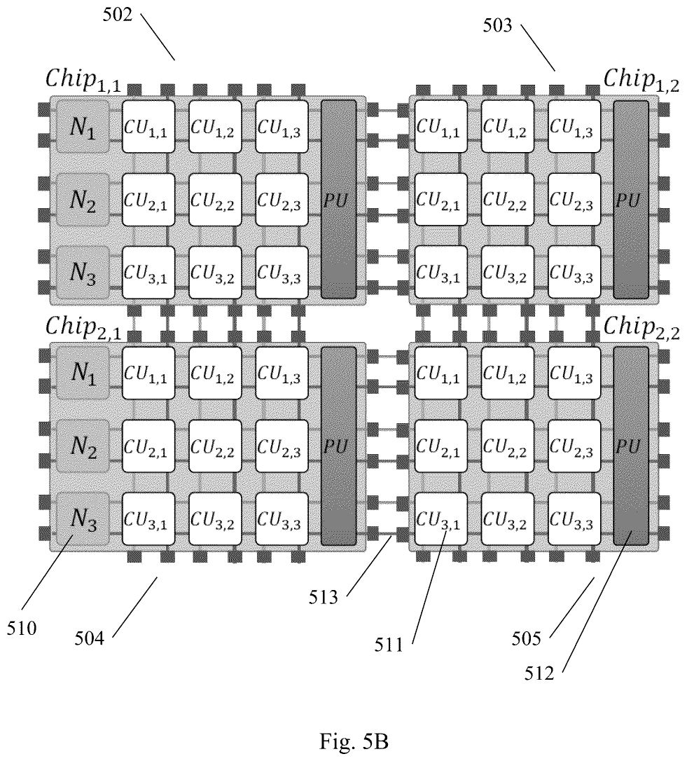

With reference to FIG. 5A, a block diagram of a “macrochip” k-by-k array (k=2) of BRIM chips is shown. Switches allow each chip to either work independently or together as a large Ising machine: As shown in the inset, the coupling units of the top right chip are either connected to the chip's own nodes or to the wires connecting them to the same row of coupling units in the neighboring chip. In the context of FIG. 5A, CU's are Coupling Units and PU's are Programming Units.

The k² chips (502, 503, 504, 505) can be connected to form a larger machine with (kN)² coupling units 513: the wires of a row of coupling units are coupled to the corresponding wires of the same row from the left and/or right neighbor chip. Similarly, the wires of the same column from upper and lower neighbors are joined. If the packaging issue of individual chips is ignored, one can simply look at the entire circuit area as one (bigger) “macrochip” Ising machine with kN nodes.

With reference to FIG. 5B, an alternate schematic diagram of a “macrochip” is shown, again having four chips 502-505, but in this embodiment only having one node 510 per row, and with each chip having one programming unit 512 for controlling all the coupling units on the chip.

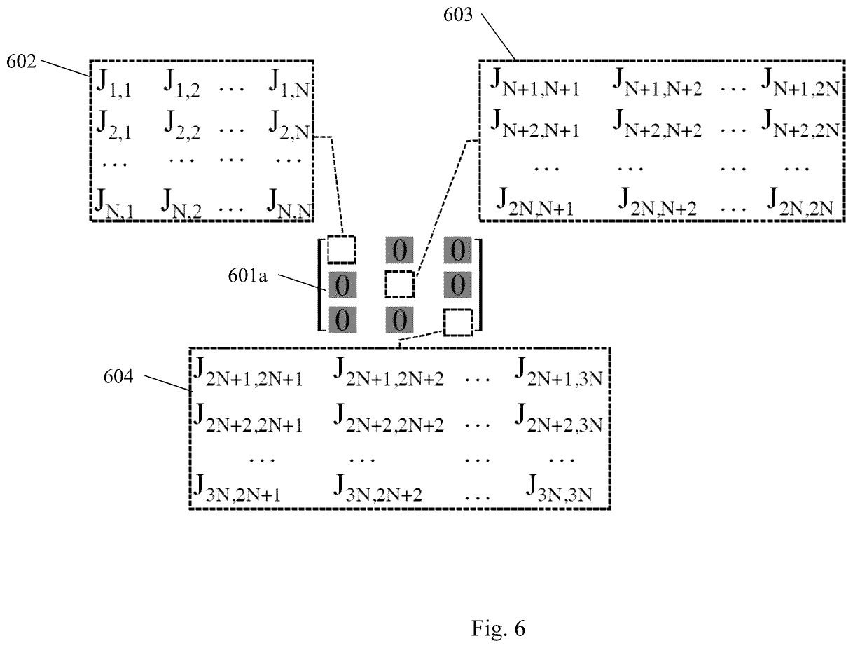

Given an Ising machine of N nodes, the disclosed system can solve multiple smaller problems simultaneously, so long as the sum of the number of nodes from each problem does not exceed N. This can be seen in the illustration shown in FIG. 6. If the shaded area of the coupling matrix is kept all zero, the matrix is effectively isolated into several smaller submatrices. This is obviously not resource-efficient: it takes k² chips to form a macrochip of kN nodes. If this macrochip were used to solve smaller problems of size N, only k such problems could be accommodated. Indeed, in that case, only the coupling arrays of the chips in the diagonal of the k×k array are being used.

Such waste is not difficult to avoid. By isolating a chip from the rest of the macrochip, it can clearly function as an independent Ising machine. In some embodiments, switches may be inserted at the nodes where the i^{th} row and column can be either connected to the i^{th} node on the chip, or to the corresponding row or column from a neighboring chip. With that support, a chip can either participate in a larger microchip configuration or operate independently. In fact, the smallest independent unit need not be a single chip, but a module of a size chosen by the designer. With reference again to FIG. 5A and FIG. 5B, where the entire figure is instead treated as one chip, each block (502-505) is a module. This chip then can either operate as one large machine or as k² smaller independent machines. In other embodiments, different systems for reconfigurability may be introduced. For example, with reference again to FIG. 5A and FIG. 5B, three types of units may be reconfigurable: the nodes 510, the diagonal couplers 511, and the interface pins 513 in each chip. In independent operation, each chip is isolated from others and operates just like a single-chip Ising machine: the nodes are in regular mode, the pins are disconnected from rows and columns of wires, and the diagonal couplers are in cross-over mode (where the wires for row i and column i are connected at the diagonal coupler (i,i)). In collective operation, corresponding rows and columns of wires are connected through the pins 513 to neighboring chips; all the diagonal couplers except on the main diagonal of the entire macrochip are switched to regular coupler mode (the main diagonal will remain in cross-over mode); and only nodes in the leftmost chips are in regular mode while other nodes on other chips will be in by-pass mode. In some configurations, a subset of the chips work collectively while the rest work independently.

While this macrochip design is conceptually straightforward, there are a number of issues concerning its implementation. The primary concern is the chip-interface. Depending on whether the chips are integrated via PCB or interposers, the chip-to-board interface may become an engineering challenge. As the interface carries fast-changing analog signals between multiple chips, they certainly make analysis of system behavior less straightforward. For this reason, in some embodiments, a device as disclosed herein may comprise an entirely digital interface. In a sense, multiple chips plus a digital interconnect are used to make a multiprocessor Ising machine.

As contemplated herein, a digital interconnect between multiple chips may take on a variety of forms, for example using any transceiver known in the art, including but not limited to SPI, I2C, Ethernet, or PCI Express (PCIe), or other bus communication standards. Use of a digital interconnect may necessitate the use of transitory or non-transitory memory for storing information received from a digital interconnect or waiting to be transferred via a digital interconnect. In some embodiments each chip of the multiple chips may comprise one or more buffers, for example divided into N regions for storing data related to N nodes.

### A Multiprocessor Architecture

By having all coupling coefficients embodied in physical units, the macrochip disclosed herein fundamentally avoids any glue computation to support multi-chip operation. While this essential feature is maintained, the multiprocessor architecture addresses the interface issues of the macrochip.

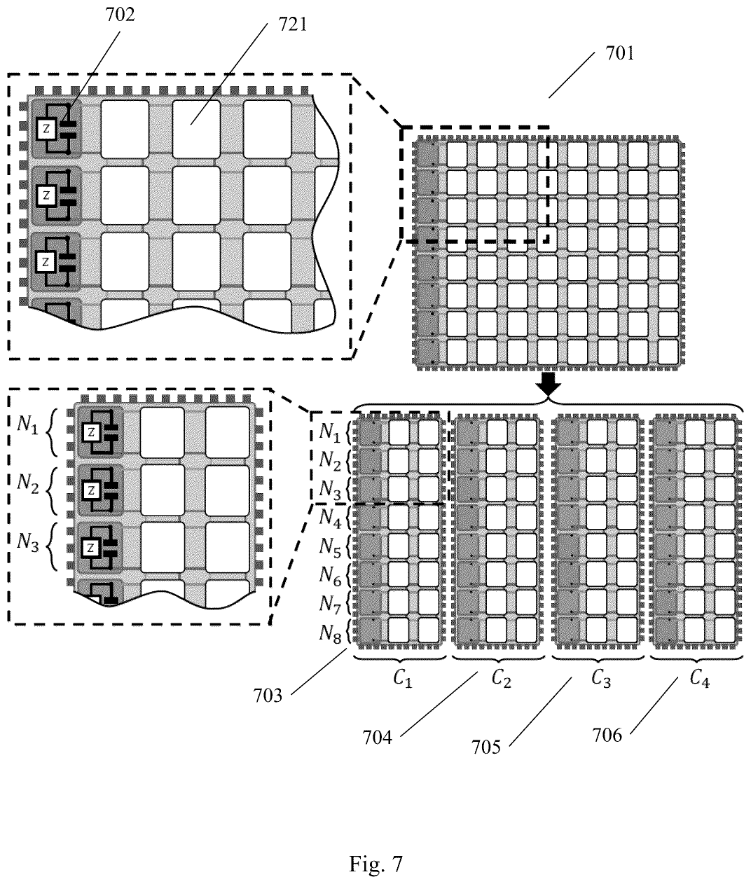

FIG. 7 shows this design. The top portion 701 depicts a logical system layout: N nodes 702 with N² coupling units 721. Physically, they can be split over, for example, 4 chips (703, 704, 705, 706), each one with a complete set of nodes. Some of these nodes (shown in orange) are merely “shadow copies” of the real nodes on some other chip. For example, node 3 (N₃) on chip C₁ may in some embodiments be just a buffer. The real node 3 is on chip C₂ (704). When node 3 changes polarity (say to −1), C₂ will communicate this information to other chips through a digital fabric (not shown). All other chips will use a buffer to maintain a −1 value for node 3 until C₂ notifies them of further changes. In other words, compared to the real node, the shadow copies are approximate in time (a bit delayed) and in value (always at a voltage rail).

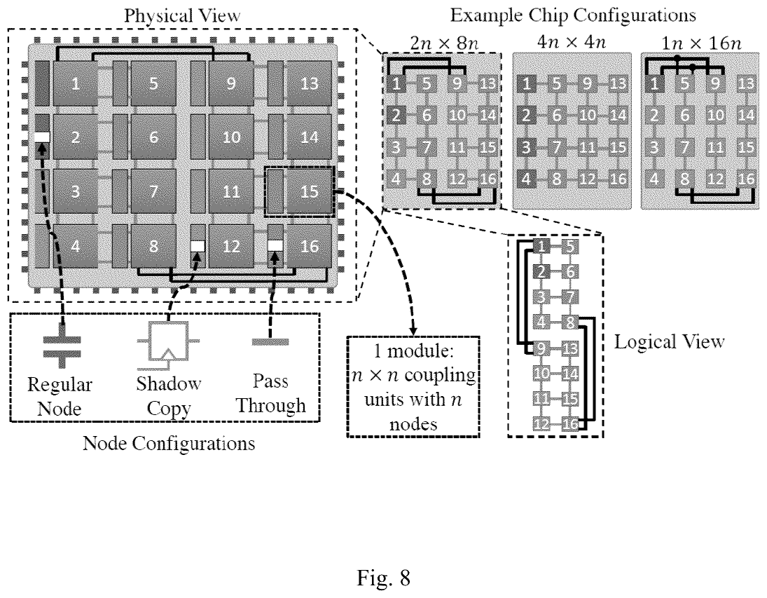

With this design, the logical structure of a single chip captures a long slice of the overall coupling matrix. This logical structure is still implemented based on a typical square baseline chip architecture. The difference is that the disclosed logical structure is built from modular, re-configurable arrays. With reference to FIG. 8, an illustration of a reconfigurable chip made of 4×4 modules each with n nodes and an n×n coupling array is shown. The nodes can operate in three different modes: regular nodes (blue), shadow copy (orange), or completely bypassed (green). These modules can be configured in three ways. (1) 4n×4n: the chip is an independent machine with 4n nodes. These 4n nodes are in the first column (blue). The nodes in the rest of the modules are bypassed (green). (2) 2n×8n: this configuration allows 4 chips to be connected into an 8n×8n system. In the current chip, only 2n nodes are regular (blue), and on nodes are shadow copies (orange). They are connected with wires into a logical array of 2 columns each with 8 arrays. (3)n×16n: Similar to the previous example, this chip is used with 15 chips to form a multiprocessor with 16n nodes. Although the depicted example of a reconfigurable logical structure is shown as a 4×4 array, it is understood that a multi-module structure may have any suitable geometry, including but not limited to 2×2, 3×3, 4×4, 5×5, 6×6, 7×7, 8×8, etc. In some embodiments, a multi-module structure may be arranged in three dimensions, for example 2×2×2, 3×3×3, 4×4×4, 5×5×5, 6×6×6, etc. Although square or cubic arrangements may be convenient, in some embodiments an array may have one or more dimensions different than the others. For example, a two-dimensional array may be arranged as X×Y×Z, where each of X, Y, and Z are selected from 2, 3, 4, 5, 6, 7, 8, 9, 10, or any other integer.

As shown in FIG. 8, a single chip can be made into a square array of k×k modules (k=4 in the example). Each module consists of an array of n configurable nodes, and n×n coupling units. The general idea is these modules can then be strung together differently for different purposes. For example, FIG. 8 shows the same group of 16 modules connected together in three configurations 4×4; 8×2; and 16×1, by changing the interconnections between the modules. In this way, this chip can be used as a single machine of 4n nodes, be part of a four-chip multiprocessor of 8n nodes, or part of a 16-chip multiprocessor of 16n nodes.

Taking the configuration of 2n×8n as a concrete example, when combined with 3 other chips of the same configuration, the system forms a complete 8n×8n coupling matrix. In FIG. 8 (bottom right) the desired logical organization of the 16 modules is shown. Among these modules, only 2 (providing 2n nodes) are configured as regular nodes (module 1 and 2 in blue); 6 are configured as shadow copies (3, 4, and 9 to 12 in orange); the rest are configured to pass through (green). In addition to different configuration of the nodes, wire connections need to change too. For instance, modules 1 and 9 have to be connected so that modules 1 to 4 and 9 to 12 can act as one 8-module tall column.

The basic idea is that when a spin changes polarity, one chip needs to communicate to all the other chips in order for them to update their shadow copies. The communication demand is, to a first approximation, fₛNlog(N), where N is the total number of spins in a system and fₛ is the frequency of spin flips. Considering a concrete example of the disclosed baseline Ising substrate: on average one spin/node flips every 10-20 ns, depending on problems being solved. Assuming the same spin flip frequency, if sixteen 8,000-spin chips were used to form a multiprocessor Ising machine, the total system would offer 32,000 spins (\sqrt{16}×8000) and would require at least 50 Tb/s (broadcast) bandwidth. In fact, due to the annealing schedule, the system has a higher spin flip frequency at the beginning of the schedule and thus would demand even more peak bandwidth.

Note that such communication is also needed for any multi-thread von Neumann solver. The difference is that compared with a state-of-the-art physical Ising machine, a von Neumann solver is orders-of-magnitude slower and thus has a correspondingly lower bandwidth demand.

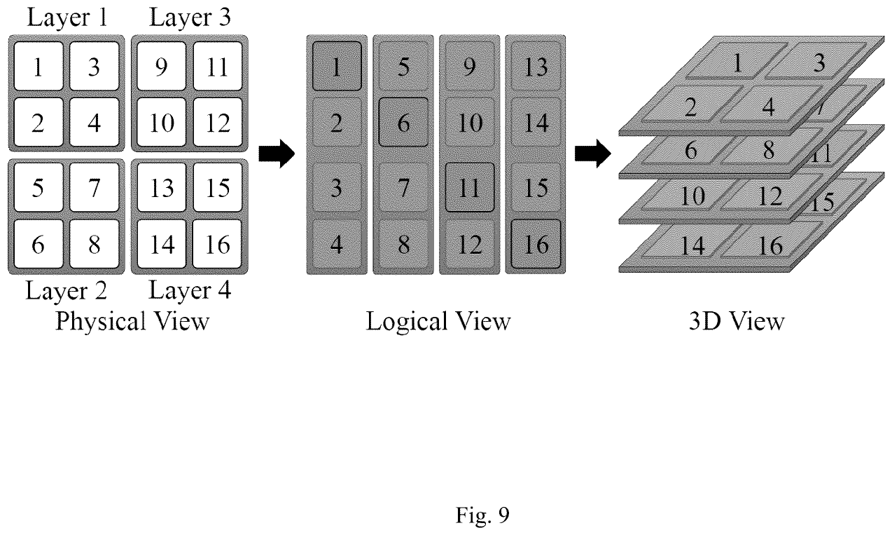

Given this significant, intrinsic bandwidth demand, a number of technological solutions immediately come to mind. Optical communication and 3D integration are both appealing options. Indeed, 3D integration is a very convenient solution to the proposed architecture. FIG. 9 shows an example 4-layer 3D IC. Nodes and their shadow copies are conveniently located on top of one another and thus can be easily connected with through-silicon vias (TSV). In fact, due to the short distance of the TSVs, shadow nodes are no longer necessary architecturally. In some embodiments, shadow nodes may still improve driving capabilities.

Finally, in some embodiments the physics of the Ising machine may be slowed down so that the communication demand matches the supply of the fabric. In the case of BRIM, this can be achieved in a combination of (at least) two ways. First, the machine's RC constant can be increased—larger coupling resistors may be used to slow down charging. For example, in some embodiments, coupling resistors may have resistance values between 5 kΩ and 50 kΩ, or between 10 kΩ and 40 kΩ, or between 30 kΩ and 35 kΩ, or about 31 kΩ. In some embodiments, larger coupling resistors than these (for example at least 100 kΩ, at least 200 kΩ, at least 500 kΩ, or between 100 kΩ and 1MΩ) may be used in order to increase the related time constants and slow down charging.

Second, the system can be stopped altogether, for example, to wait out a congestion. No matter how these mechanisms are combined, the math is simple: to reduce bandwidth demand by 2×, the machine must be slowed down by 2×. Other methods, discussed further below, may be used to reduce the bandwidth demand without a corresponding reduction in performance.

Concurrent operation of multiple Ising machines (solving the same problem) can be roughly described as a combination of each machine performing local search independently and exchanging information about the state of spins with each other. A surprisingly consequential design parameter is how long to wait before communicating a change of spin to others. Sending any change immediately seems the natural choice as the multiprocessor functions most closely to a single, large Ising machine. However, waiting has its merit too. During a window of time, a spin may flip back and forth multiple times. With some waiting, wasting bandwidth on unnecessary updates may be avoided. In this regard, the longer the wait, the more bandwidth can be saved. In reality, however, the wait time has implications on the solution quality, as explained further below.

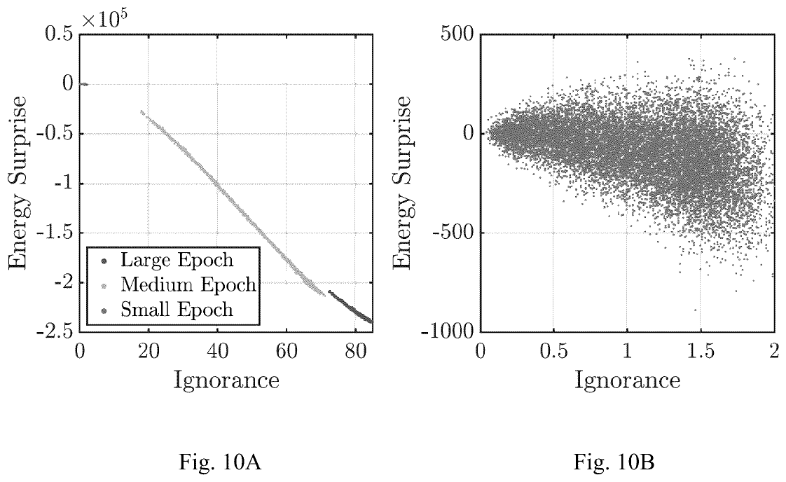

In a concurrent operation, every solver has some “ignorance” of the true state of spins mapped on other solvers. Taking a 4-solver system as an example, at any point, the system's spin state can be represented as S_{g}=[A, B, C, D)]^{T} where each letter represents the spin vector of each machine. Due to communication delay as well as the waiting mentioned above, the first solver's belief of the current state is thus S₁=[A, B^{t}, C^{t}, D^{t})]^{T}. In its local search, it is essentially trying to optimize the energy of this believed state E(S₁). A low E(S₁) does not necessarily mean that the energy of the system's true state E(S_{g}) is also low. Suppose that the solver is then provided the true state of other solvers and recalculates the energy. The difference may then be defined as the energy surprise (Eₛᵤᵣₚᵣᵢₛₑ=E(S₁)E(S_{g})). In this way, a positive value means that the current state has lower (better) energy than what the solver believed prior to update: in other words, it is a good surprise. FIG. 10A and FIG. 10B show the empirical observations of the energy surprises.

With reference to FIG. 10A and FIG. 10B, the degree of ignorance and the corresponding energy surprise for different epoch sizes are shown. The graph has 8000 nodes which are partitioned and mapped onto 8 solvers with each solving 1000 nodes. FIG. 10A shows the communication for small, medium and large epochs. FIG. 10B shows a magnified segment near the origin.

This particular experiment is obtained by solving an 8000-node problem divided into 8 sub-problems each solved by a Simulated Annealing (SA) solver. After initialization, each solver uses the state of the other 7000 nodes to compute the biases. Then they perform a local search for a fixed amount of time (called an epoch) before communicating their states to one another. At the epoch boundary, the amount of ignorance can be shown measured by the percentage of spins whose external spins are not up-to-date. The energy surprise is also calculated. The figure shows the results of every epoch from 20 runs.

When the epoch time is long, more spin changes occur from other solvers. As a result, any single solver is under a higher degree of ignorance of the external state, leading to a higher degree of misjudgement and a larger magnitude of surprise. When the epoch is longer than a certain value, the energy surprise is highly correlated with degree of ignorance. In this regime, one can say the parallel solvers are clearly doing a poor job (also reflected in very poor final solution quality not shown in the graph). So far, this message is consistent with earlier analysis that decomposed sub-problems are not independent from one another. However, when the epoch time goes below a certain threshold, the situation seems to go through a phase change: now, the energy surprise is no longer uniformly negative. At any rate, the magnitude of surprise gets lower. In other words, despite having some ignorance, the solvers can still find reasonable solutions. In fact, sometimes the solution is better than believed under the ignorance. Indeed, the overall solution quality is no worse (and as a matter of fact statistically better) than running the solvers sequentially (thus without any ignorance).

Therefore, in some embodiments, multiple solvers can operate in parallel as long as they keep each other informed “sufficiently promptly”. This means that a short epoch time is advantageous, which generally means a high communication demand.

Another important aspect of the design is about spin flips introduced to the system to prevent the system from becoming stuck at a local minimum. (These are referred to herein as induced spin flips.) These spin flips are generally applied stochastically, similarly to an accepted proposal in the Metropolis algorithm (W. K. Hastings, Biometrika, April 1970). In a practical implementation, randomness is often of a deterministic, pseudo-random nature. As a result, if the pseudo random number generator (PRNG) is properly synchronized on each chip, it can be guaranteed that each chip will generate the same output everywhere simultaneously. In this way, induced spin flips may be applied without explicit communication. In other words, instead of randomly choosing, say, node 3 to flip and then sending an explicit message from the chip that contains node 3 to other chips informing them of the flip, the PRNG on all chips would simultaneously induce node 3 to be flipped and update the nodal capacitor or the shadow register at about the same time.

### Batch Mode Operation

While careful design of concurrent operation can achieve noticeable bandwidth savings (about 1.5× in some embodiments), a completely different mode of operation—batch mode—can allow a more substantial savings (about 5×). This mode leverages the fact that a common, if not universal, mode of using an annealer is to perform a batch of runs with different initial states and take the best solution from the batch. Knowing that there exists a batch of runs of the same setup, they may be staggered in a fairly straightforward manner to reduce the necessary communication.

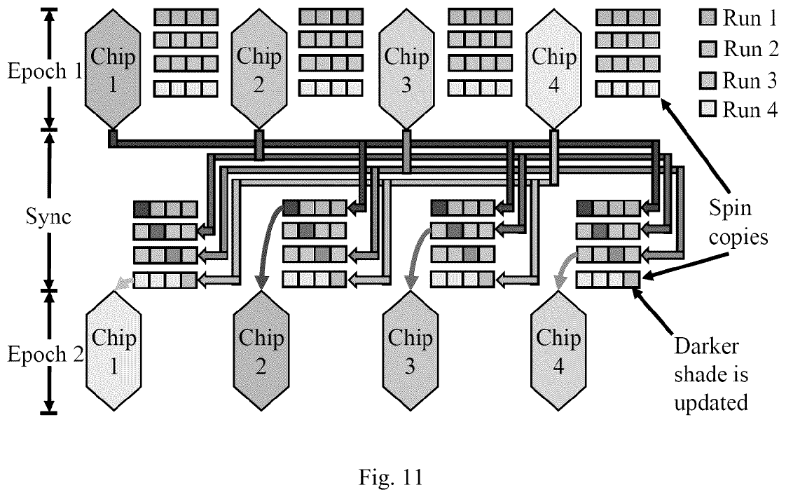

The key idea is illustrated in FIG. 11. Viewed vertically, a single job (from one initial state, say Job 1) is still spread out over multiple solvers (on Chip 1 in epoch 1, on Chip 2 in epoch 2, etc.) like in concurrent mode. So each chip is still just annealing for its part of the problem. But the solvers now work sequentially. At the end of Epoch 1, Chip 1 passes on the updated spin state to others (indicated in the figure by the change to a darker red for the first quarter of spins in all chips). Chip 2 then picks up Job 1 and continues exploration of the second quarter of the spins.

Viewed horizontally, in every epoch each of the 4 chips works on a different job (indicated by different colors). In the synchronization phase, they exchange the updated state and afterward start annealing on a different job. The key advantage of this approach is that each epoch can be much longer in time—without creating any ignorance. As already discussed, with a longer epoch, the total communication bandwidth needed can be much less than that needed to communicate every single event of spin flip.

To exploit parallelism, in batch mode, n different runs (from different initial states) may in some embodiments be performed simultaneously across n solvers. As a result, the system as a whole needs to carry n copies of states instead of just one in the concurrent mode. To support this, a modest increase in storage is needed (n×N) bits per solver) to keep the states for different runs.

Finally, it is tempting to think that a good way to run batch mode is just like in a von Neumann system where every machine conducts an independent run. This is decidedly less efficient in a multiprocessor Ising machine: If an entire problem is solved by one machine, it is necessary to context-switch in the new parameters at the end of every epoch. The data volume is O(bN²) bits, where b is the bit width of coupling weight. By contrast, in the disclosed batch mode, the data volume is O(N).

### Experimental Examples

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### Experimental Methodology

Because Ising machine development is still in its early stages, access to physical systems is difficult. Most comparisons disclosed herein are therefore performed with a mixture of modeling, using results reported in literature, and measuring time of simulated annealing (SA). In all the experiments, SA is natively executed, while BRIM's dynamical system evolution is modeled by solving differential equations using the 4th-order Runge-Kutta method. When comparing to reported results, the present experiments are limited by the type of benchmarks that were used in literature for direct comparison. Cross-benchmark comparison is full of pitfalls, as there is no easy way to compare solution quality for different problems Fortunately, a few benchmarks (K-graphs) have been commonly used. One such graph that is used for comparison is known as K16384 (see Kosuke Tatsumura, et al., Nature Electronics (1 Mar. 2021)) and contains 16,384 spins with all-to-all connections. Simulating dynamical systems with differential equations can be orders-of-magnitude slower than cycle-level microprocessor simulation. Simulating 1 μs of dynamics in K16384 takes about 3 days on a very powerful server. Therefore, it was only used for direct performance comparison. Smaller K-graphs (e.g., K2000, Takahiro Inagaki, et al., Science (2016)) are used for some additional analyses.

While the execution time of SA is generally the closest thing to a standard performance yardstick, there are actually quite a few subtleties. First, Isakov's algorithm (S. Isakov, et al., Computer Physics Communications, July 2015) was chosen as it is the fastest version known. Second, an optimization was applied using dense matrix representation. This exploits fully connected graphs like the K-graphs to improve performance. Finally, researchers have tuned the annealing schedules for these specific graphs. This tuning turns out to have a significant impact on execution time. Similar tuning on the disclosed hardware annealing schedule could potentially also improve performance. Unfortunately, such tuning was not yet possible for these experiments as the simulation cost was prohibitive.

### Single Solver Baseline

To get a sense of the landscape of physical Ising machines and digital accelerators for simulated annealing, in FIG. 12 results of a few uniprocessor Ising machines are shown running K2000: a BRIM chip (simulated), simulated annealing (measured), and the reported results for STATICA (K. Yamamoto, et al., IEEE Journal of Solid-State Circuits, 2021); CIM (T. Inagaki, et al., Science, 2016); and two variants of simulated bifurcation machine (SBM) (H. Goto, et al., Science Advances, 2021). Many other machines are missing from this comparison because they simply cannot map the graph. Despite its seemingly modest size (2000 nodes), K2000 is a fully connected graph and requires millions of nodes for machines with only local coupling.

With reference to FIG. 12, the performance of a K2000 graph on diverse machines is shown as solution cut value on the y-axis (higher is better) and execution time on the x-axis. At every time scale, the machine went through 100 runs. In machines where multiple time scale results were available, the average results for each time scale are shown in a dashed line and the range is shown as a shaded region. Results with only one time scale are shown as bars with the dots indicating the range and the average cut values.

For this graph, BRIM could reach the best known solution of 33,337 in 11 μs. The only other machine that could reach similar solution quality was dSBM in 2 ms, about 180× slower. Even if lower solution quality was acceptable, a single-chip BRIM is still roughly two orders of magnitude faster than the fastest annealer. Current CIM implementations use a computational subsystem to simulate coupling between spins. It is therefore not strictly a physical Ising machine, but a hybrid one. One could postulate that if the designers could figure out a fully physical coupling mechanism-which may not be easy or even possible-its performance may improve.

In summary, a properly designed physical Ising machine can be 6 orders of magnitude faster than a conventional simulated annealer (SA) and about two orders of magnitude faster than the state-of-the-art computational annealer. The only disadvantage of a physical Ising machine over a computational annealer is that the latter can easily scale to solve bigger problems. Below, it is shown how the proposed multiprocessor architecture addresses this issue. The focus is now narrowed to comparing against just SA and SBM as the latter is the fastest system currently known.

### High-Level Comparison

The disclosed multiprocessor BRIM (mBRIM) architecture with SBM is compared using the larger K16384 graph as the benchmark. This allows for direct comparison of solution quality and performance with reported results in the literature. A 4-chip multiprocessor was assumed. Each chip was a BRIM-style electronic Ising machine with 8192 nodes. Such a chip should have a smaller die size (about 80 mm² in a 45 nm technology) and consume much less power (less than 10 W) than a single FPGA used in SBM. Three incarnations of this multiprocessor were used as proxies for different implementation choices:
(1) mBRIM_{3D}: A 3D-integrated version where communication is essentially instantaneous and without bandwidth limit;
(2) mBRIM_{HB}: A system with high communication bandwidth. Each chip is provided with three dedicated channels each of 250 GB/s. The total bandwidth is thus close to that of HBM.
(3) mBRIM_{LB}: A system with low communication bandwidth (4× less than mBRIM_{HB}).

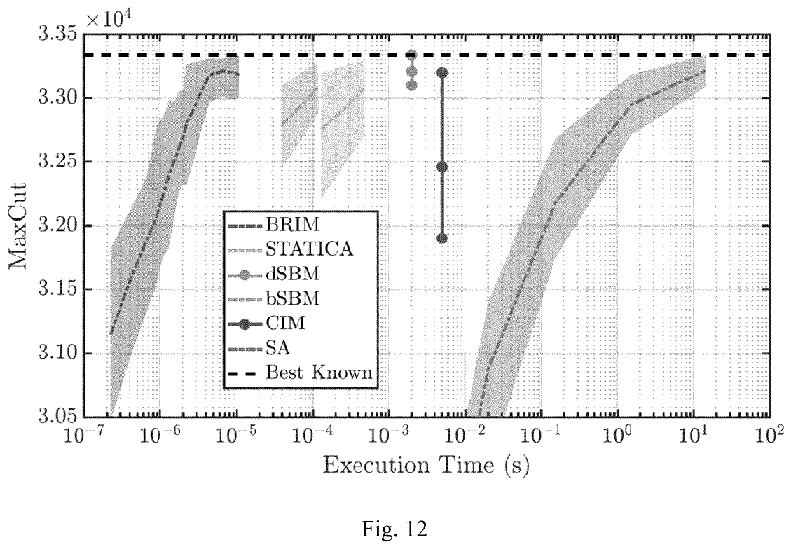

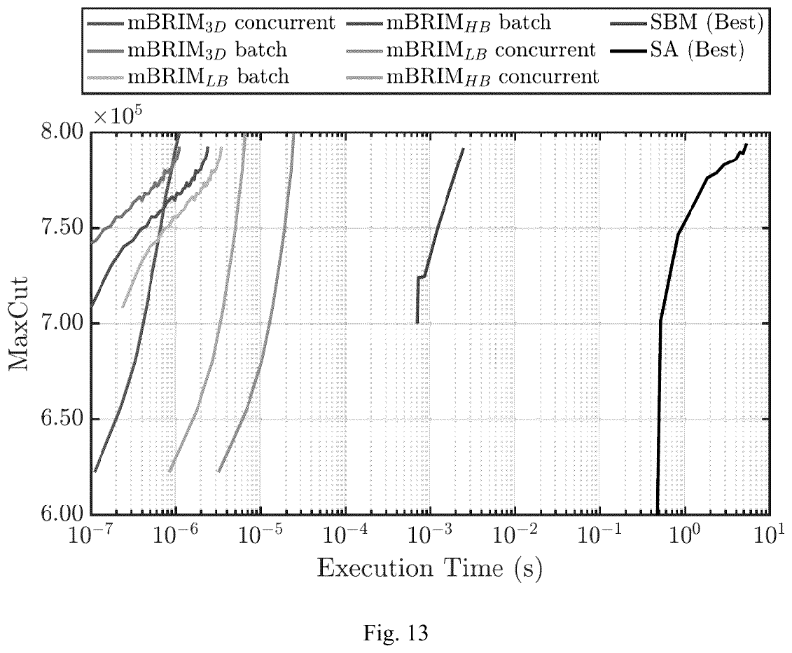

FIG. 13 shows the best solution quality and time obtained by different mBRIMs, by an 8-FPGA implementation of SBM and by SA. For clarity, only the results of the best-quality run are shown in the graph. If the highest performing mBRIM (mBRIM_{3D} concurrent mode) were compared with SBM, mBRIM arrives at a much better solution quality (793,423 to 799,292 vs SBM's best result of about 792,000) and is about 2200× faster (1.1 μs vs 2.47 ms). Even the bandwidth constrained configuration (mBRIM_{LB}), which would operate in batch mode, was more than 700× faster than SBM, also with higher solution quality.

Next the impact of the bandwidth limitation is examined. As already discussed above, if the communication bandwidth between chips is insufficient, it is possible in some embodiments to slow down the Ising machines to cope. The impact, of course, is that it is necessary to wait longer to obtain the solution. Both mBRIM_{HB} and mBRIM_{LB} were slower than mBRIM_{3D} due to congestion-induced stalling. In these bandwidth limited situations, the disclosed batch mode operation is a reasonably effective tool and can improve execution speed. Specifically, batch mode allows the same amount of annealing to be finished by 2.8× and 7× faster for mBRIM_{HB} and mBRIM_{LB}, respectively. With batch mode, mBRIM_{HB} is only about 2× slower than mBRIM_{3D} and mBRIM_{LB} is another 1.4× slower. However, the solution quality is reduced to 792,728.

Finally, mBRIM was compared to SA. It is shown that to get to the same solution quality, mBRIM is about 4.5×10⁶ faster. This compares to the 1.3×10⁶ speedup in K2000. Note here that there is an extraordinary difference (about 140×) for SA's performance due to tuning the annealing schedule.

### In-Depth Analysis

It may be beneficial to understand how different types of solver work from first principles. No matter what solver is used, it is necessary to explore the high-dimensional energy landscape sufficiently to achieve a good solution. As an example, for an 800-node graph, simulated annealing (SA) and BRIM explored 148K and 115K different states respectively to arrive at comparable solution quality. In BRIM, on average, there is a spin flip every 20 ps.

In (sequential) SA, flipping individual spins was achieved computationally: the energy of an alternative configuration (with a particular spin flipped) was calculated and based on the energy, the new state was probabilistically accepted. Roughly speaking, 140,000 instructions executed per spin flip were counted when running SA.

Simulated bifurcation (SB) is an entirely new computational approach. It can be thought of as simulating a dynamical system. Thanks to its algorithm design, it is easier to parallelize. Thus, despite having similar workload, it can be faster. A non-trivial portion of SA is also massively parallel. However, there is no effort for custom-hardware implementation of parallel SA. Nevertheless, accelerating SB to the level of BRIM would require about 1000× more computational throughput or about 2 Peta Ops per second. It is therefore clear why physical Ising machines are more attractive even compared to the best computational accelerator.

As already discussed above, the degree of global state ignorance can have a significant impact on solution quality. Thus, in concurrent runs, it was necessary to let each solver frequently update all others. In batch mode, this was no longer an issue as different solvers for the same run essentially run sequentially and only need to communicate cumulative state changes between the beginning and end of the same epoch (which are referred to as bit change to differentiate from spin flips). If a spin flips four times in an epoch and ends up at the same state as the beginning of the epoch, it is not necessary to communicate anything. In other words, there are four spin flips but 0 bit change. Intuitively, the longer the epoch, the more spin flips will result in no bit change. FIG. 14A and FIG. 14B confirm this intuition quantitatively. The number of spin flips during an epoch was measured and the number of bit changes was counted. For 3.3 ns epochs, both numbers and their ratio are shown as the annealing proceeds in FIG. 14A. FIG. 14B shows the ratio as a function of different epoch sizes.

With reference to FIG. 14A and FIG. 14B, FIG. 14A shows the evolution of flips and bit changes over time for a 4 chip BRIM with a fixed epoch of 3.3 ns. The left vertical axis corresponds to flips (solid blue line) and bit changes (dashed blue line). The right vertical axis corresponds to the ratio of flips to bit changes shown in red. FIG. 14B shows the correlation of the average ratio of flips to bit changes with epoch size. The ratio increases almost linearly with increasing epoch size.

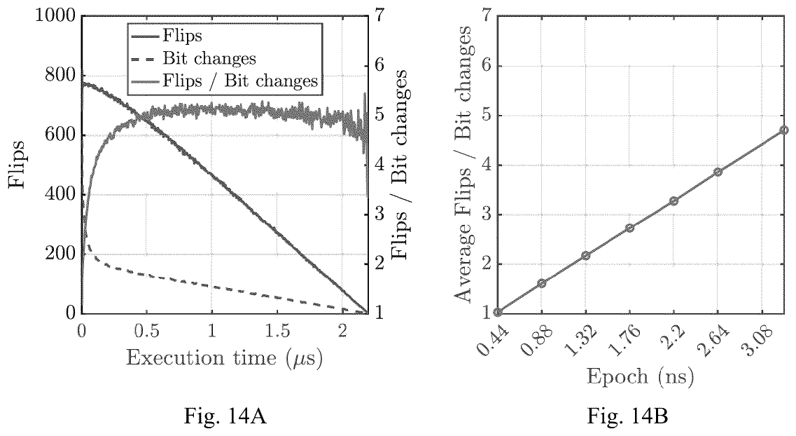

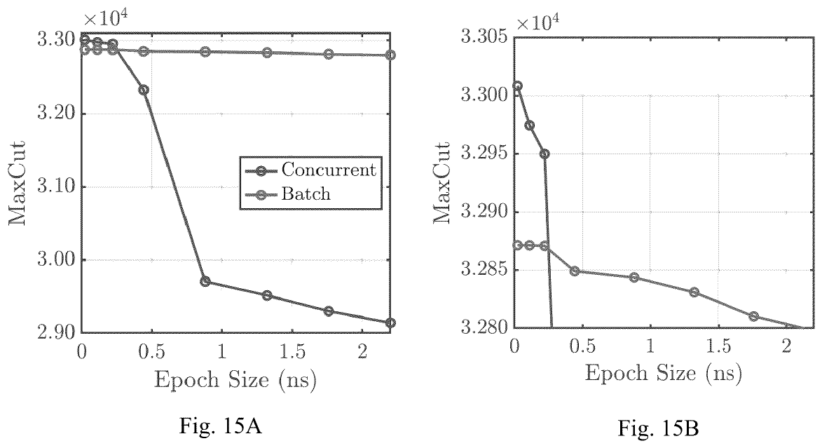

The number of spin flips during an epoch were measured the number of bit changes were counted. In FIG. 14A, both numbers and their ratio are shown as the annealing proceeds. For a fixed epoch size, the ratio is rather stable after an initial period. FIG. 14B shows the ratio as a function of different epoch sizes. Not surprisingly, the longer the epoch the higher the ratio. As shown, if an epoch size of about 3 ns is used, traffic demand can be reduced by around 4-5× compared to using sub-nanosecond epochs. Increasing epoch size does degrade solution quality as can be seen in FIG. 15A and FIG. 15B, where the solution quality is shown as a function of epoch size. The best solution quality was achieved with concurrent mode with a small epoch size. When bandwidth is sufficient, this is the best mode to use. In a bandwidth-bound system, the dynamical system needs to be slowed down. In that case, a 4-5× traffic reduction means the dynamical system can run about 4-5× faster. Achieving a traffic reduction in turn requires longer epochs. In such a case, the concurrent mode does not tolerate longer epochs well and the solution quality drops quickly and significantly. Batch mode, on the other hand, is much more tolerant to longer epochs as the solution quality does go down but only very slightly. Thus in a bandwidth-bound system, batch mode will be very useful in not sacrificing execution speed while maintaining high solution quality.

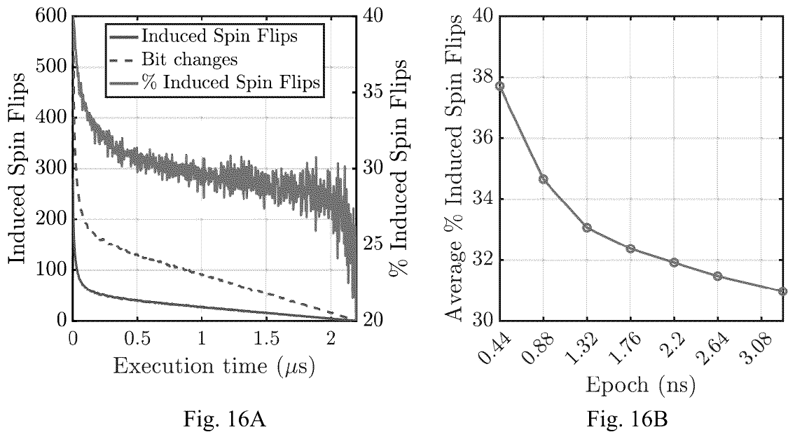

Finally, bandwidth reduction was examined when coordinating induced spin flips. FIG. 16A shows the amount of bit changes and induced spin flips with the evolution of time. The percentage of bit changes that are induced spin flips is also plotted. Of course, the value is a function of epoch size. FIG. 16B shows the average percentage with different epoch sizes. Clearly a non-trivial amount of communication (30-38%) can be saved with the optimization of coordinating induced flips. In a bandwidth constrained system, a corresponding improvement in execution time (about 1.5×) can be expected.

FIG. 16A shows the evolution of induced spin flips and bit changes over time for a 4 chip BRIM with a fixed epoch of 3.3 ns. The left vertical axis corresponds to induced spin flips (solid blue line) and bit changes (dashed blue line). The right vertical axis corresponds to the percentage of bit changes that are induced spin flips shown in red. FIG. 16B shows the correlation of the average percentage of induced spin flips with epoch duration.

Contrast with other Parallel Processing

Finally, it is noted that communication among distributed agents is clearly a common component and performance bottleneck in parallel processing. Thus, in exploring solutions for Ising machines, some wheels may have been reinvented. For example, using shadow copies is a necessity for the disclosed system the same way keeping copies (ghosts) of non-local neighbors is in parallel algorithms. Also, techniques of reducing communication while limiting performance consequences have been explored in different contexts: sending lower precision data-sometimes just 1 bit, using lossy compression, reducing the number of elements transmitted, or even skipping rounds. Compared to these situations, two key differences can be highlighted specifically for the case of Ising machines:
(1) Scale of the problem: Ising machines are dynamical systems and can evolve extremely quickly. They thus present enormous raw communication demand without optimizations. For instance the disclosed 4 BRIM chips (each about 80 mm² in 45 nm technology) would need about 4 TB/s.
(2) Design flexibility: Optimizations such as batch mode and coordinating induced spin flips are possible because the freedom to orchestrate the evolution process of the underlying Ising machine can be exploited. As a result, there is no additional logic such as compression and yet solution quality can be maintained while reducing communication demand to only 218 GB/s (20× reduction).

### CONCLUSION

Physical Ising machines can solve Ising formula optimization problems with extreme speed and energy efficiency, even when compared with special-purpose (von Neumann) accelerators. However, existing Ising machines have a fixed capacity. If a divide-and-conquer strategy is used, the benefit of using Ising machines reduces quickly when the problem is even slightly bigger than the machine capacity. The devices disclosed herein are fundamentally designed to cooperate with other machines to solve a larger problem. This disclosure presents an architectural design and optimization of a multiprocessor Ising machine. The experimental results related to the design can be summarized into a few key takeaway points:
(1) Even under conservative conditions (fewer chips, less chip area and power consumption) the multiprocessor can achieve about 2200× speedup compared to the state-of-the-art computational accelerator.
(2) With the proposed multiprocessor architecture, a physical Ising machine can now also scale up and solve bigger problems. While it is difficult to compare speedups over different problems, it is safe to say that the performance advantage of a multiprocessor BRIM over its von Neumann counterpart is as significant as in the case of single-chip BRIM.
(3) Given the extreme speed of a physical Ising machine, communication bandwidth can be a potential bottleneck and the machine needs to slow down correspondingly. In these cases, batch mode operation can lead to about 4-5× reduction in communication demand, translating to about 4-5× improvement in processing throughput.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### REFERENCES CITED

The following publications are incorporated herein by reference in their entirety.
Martin Abadi, Ashish Agarwal, Paul Barham, Eugene Brevdo, Zhifeng Chen, Craig Citro, Gregory S. Corrado, Andy Davis, Jeffrey Dean, Matthieu Devin, Sanjay Ghemawat, Ian J. Goodfellow, Andrew Harp, Geoffrey Irving, Michael Isard, Yangqing Jia, Rafal Józefowicz, Lukasz Kaiser, Manjunath Kudlur, Josh Levenberg, Dan Mané, Rajat Monga, Sherry Moore, Derek Gordon Murray, Chris Olah, Mike Schuster, Jonathon Shlens, Benoit Steiner, Ilya Sutskever, Kunal Talwar, Paul A. Tucker, Vincent Vanhoucke, Vijay Vasudevan, Fernanda B. Viégas, Oriol Vinyals, Pete Warden, Martin Wattenberg, Martin Wicke, Yuan Yu, and Xiaoqiang Zheng. 2016. TensorFlow: Large-Scale Machine Learning on Heterogeneous Distributed Systems. CoRR abs/1603.04467 (2016). arXiv: 1603.04467 http://arxiv.org/abs/1603.04467
David H Ackley, Geoffrey E Hinton, and Terrence J Sejnowski. 1985. A learning algorithm for Boltzmann machines. Cognitive science 9, 1 (1985), 147-169.
Richard Afoakwa, Yiqiao Zhang, Uday Kumar Reddy Vengalam, Zeljko Ignjatovic, and Michael Huang. 2021. BRIM: Bistable Resistively-Coupled Ising Machine. 2021 IEEE International Symposium on High-Performance Computer Architecture (HPCA) (2021), 749-760. https://doi.org/10.1109/HPCA51647.2021.00068
Dan Alistarh, Torsten Hoefler, Mikael Johansson, Sarit Khirirat, Nikola Konstantinov, and Cédric Renggli. 2018. The Convergence of Sparsified Gradient Methods. In Proceedings of the 32nd International Conference on Neural Information Processing Systems (Montréal, Canada) (NIPS'18). Curran Associates Inc., Red Hook, NY, USA, 5977-5987.
Dan Alistarh, Jerry Li, Ryota Tomioka, and Milan Vojnovic. 2016. QSGD: Randomized Quantization for Communication-Optimal Stochastic Gradient Descent. CoRR abs/1610.02132 (2016). arXiv: 1610.02132 http://arxiv.org/abs/1610.02132
Rami Barends, Alireza Shabani, Lucas Lamata, Julian Kelly, Antonio Mezzacapo, Urtzi Las Heras, Ryan Babbush, Austin G Fowler, Brooks Campbell, Yu Chen, et al. 2016. Digitized adiabatic quantum computing with a superconducting circuit. Nature 534, 7606 (2016), 222-226.
William J. Barry, Mark T. Jones, and Paul E. Plassmann. 1998. Parallel adaptive mesh refinement techniques for plasticity problems. Advances in Engineering Software 29, 3 (1998), 217-225. https://doi.org/10.1016/S0965-9978 (98) 00040-4
Debraj Basu, Deepesh Data, Can Karakus, and Suhas Diggavi. 2019. Qsparse-LocalSGD: Distributed SGD with Quantization, Sparsification, and Local Computations. Curran Associates Inc., Red Hook, NY, USA.
Natalia G Berloff, Matteo Silva, Kirill Kalinin, Alexis Askitopoulos, Julian D Töpfer, Pasquale Cilibrizzi, Wolfgang Langbein, and Pavlos G Lagoudakis. 2017. Realizing the classical XY Hamiltonian in polariton simulators. Nature materials 16, 11 (2017), 1120-1126.
Jeremy Bernstein, Yu-Xiang Wang, Kamyar Azizzadenesheli, and Anima Anandkumar. 2018. signSGD: compressed optimisation for non-convex problems. CoRR abs/1802.04434 (2018). arXiv: 1802.04434 http://arxiv.org/abs/1802.04434
Fabian Bohm, Guy Verschaffelt, and Guy Van der Sande. 2019. A poor man's coherent Ising machine based on opto-electronic feedback systems for solving optimization problems. Nature Communications 10, 1 (2019), 3538. https://doi. org/10.1038/s41467-019-11484-3
Sergio Boixo, Troels F Rønnow, Sergei V Isakov, Zhihui Wang, David Wecker, Daniel A Lidar, John M Martinis, and Matthias Troyer. 2014. Evidence for quantum annealing with more than one hundred qubits. Nature physics 10, 3 (2014), 218-224.
Michael Booth, Steven P. Reinhardt, and Aidan Roy. 2017. Partitioning Optimization Problems for Hybrid Classical/Quantum Execution. Technical Report (2017). https://docs.ocean.dwavesys.com/projects/qbsolv/en/latest/_downloads/bd15a2d8f32e587e9e5997ce9d5512cc/qbsolv_techReport.pdf
Paul I Bunyk, Emile M Hoskinson, Mark W Johnson, Elena Tolkacheva, Fabio Altomare, Andrew J Berkley, Richard Harris, Jeremy P Hilton, Trevor Lanting, Anthony J Przybysz, et al. 2014. Architectural considerations in the design of a superconducting quantum annealing processor. IEEE Transactions on Applied Superconductivity 24, 4 (2014), 1-10.
KyungHyun Cho, Alexander Ilin, and Tapani Raiko. 2011. Improved learning of Gaussian-Bernoulli restricted Boltzmann machines. In International conference on artificial neural networks. Springer, 10-17.
Jeffrey Chou, Suraj Bramhavar, Siddhartha Ghosh, and William Herzog. 2019. Analog Coupled Oscillator Based Weighted Ising Machine. Scientific Reports 9, 1 (2019), 14786. https://doi.org/10.1038/s41598-019-49699-5
Chase Cook, Hengyang Zhao, Takashi Sato, Masayuki Hiromoto, and Sheldon X. D. Tan. 2019. GPU Based Parallel Ising Computing for Combinatorial Optimization Problems in VLSI Physical Design. arXiv: 1807.10750 [physics.comp-ph]
D-WAVE. 2014. minorminer. https://github.com/dwavesystems/minorminer
D-WAVE. 2022. Operation and Timing. https://docs.dwavesys.com/docs/latest/c_qpu_timing.html
Zachary DeVito, Niels Joubert, Francisco Palacios, Stephen Oakley, Montserrat Medina, Mike Barrientos, Erich Elsen, Frank Ham, Alex Aiken, Karthik Duraisamy, Eric Darve, Juan Alonso, and Pat Hanrahan. 2011. Liszt: A domain specific language for building portable mesh-based PDE solvers. In SC '11: Proceedings of 2011 International Conference for High Performance Computing, Networking, Storage and Analysis. 1-12. https://doi.org/10.1145/2063384.2063396
Melih Elibol, Lihua Lei, and Michael I. Jordan. 2020. Variance Reduction with Sparse Gradients. CoRR abs/2001.09623 (2020). arXiv: 2001.09623 https://arxiv. org/abs/2001.09623
Hayato Goto, Kotaro Endo, Masaru Suzuki, Yoshisato Sakai, Taro Kanao, Yohei Hamakawa, Ryo Hidaka, Masaya Yamasaki, and Kosuke Tatsumura. 2021. High-performance combinatorial optimization based on classical mechanics. Science Advances 7, 6 (2021), eabe7953. https://doi.org/10.1126/sciadv.abe7953 arXiv: https://www.science.org/doi/pdf/10.1126/sciadv.abe7953
Hidenori GYOTEN, Masayuki HIROMOTO, and Takashi SATO. 2018. Area Efficient Annealing Processor for Ising Model without Random Number Generator. IEICE Transactions on Information and Systems E101.D, 2 (2018), 314-323. https://doi.org/10.1587/transinf.2017RCP0015
Ryan Hamerly, Takahiro Inagaki, Peter L McMahon, Davide Venturelli, Alireza Marandi, Tatsuhiro Onodera, Edwin Ng, Carsten Langrock, Kensuke Inaba, et al. 2018. Scaling advantages of all-to-all connectivity in physical annealers: the Coherent Ising Machine vs. D-Wave 2000Q. D-Wave 2000Q arXiv (2018).
Ryan Hamerly, Takahiro Inagaki, Peter L McMahon, Davide Venturelli, Alireza Marandi, Tatsuhiro Onodera, Edwin Ng, Carsten Langrock, Kensuke Inaba, Toshimori Honjo, et al. 2019. Experimental investigation of performance differences between coherent Ising machines and a quantum annealer. Science advances 5, 5 (2019), eaau0823.
R Hamerly, A Sludds, L Bernstein, M Prabhu, C Roques-Carmes, J Carolan, Y Yamamoto, M Soljačić, and D Englund. 2019. Towards Large-Scale Photonic Neural-Network Accelerators. In 2019 IEEE International Electron Devices Meeting (IEDM). IEEE, 22-8.
R. Harris, M. W. Johnson, T. Lanting, A. J. Berkley, J. Johansson, P. Bunyk, E. Tolkacheva, E. Ladizinsky, N. Ladizinsky, T. Oh, F. Cioata, I. Perminov, P. Spear, C. Enderud, C. Rich, S. Uchaikin, M. C. Thom, E. M. Chapple, J. Wang, B. Wilson, M. H. S. Amin, N. Dickson, K. Karimi, B. Macready, C. J. S. Truncik, and G. Rose. 2010. Experimental investigation of an eight-qubit unit cell in a superconducting optimization processor. Phys. Rev. B 82 (July 2010), 024511. Issue 2. https://doi. org/10.1103/PhysRevB.82.024511
Takahiro Inagaki, Yoshitaka Haribara, Koji Igarashi, Tomohiro Sonobe, Shuhei Tamate, Toshimori Honjo, Alireza Marandi, Peter L McMahon, Takeshi Umeki, Koji Enbutsu, et al. 2016. A coherent Ising machine for 2000-node optimization problems. Science 354, 6312 (2016), 603-606.
S. V. Isakov, I. N. Zintchenko, T. F. Rønnow, and M. Troyer. 2015. Optimised simulated annealing for Ising spin glasses. Computer Physics Communications 192 (July 2015), 265-271. https://doi.org/10.1016/j.cpc.2015.02.015
Richard M. Karp. 1972. Reducibility among Combinatorial Problems. Springer US, Boston, MA, 85-103. https://doi.org/10.1007/978-1-4684-2001-2_9
Kihwan Kim, M-S Chang, Simcha Korenblit, Rajibul Islam, Emily E Edwards, James K Freericks, G-D Lin, L-M Duan, and Christopher Monroe. 2010. Quantum simulation of frustrated Ising spins with trapped ions. Nature 465, 7298 (2010), 590-593.
Andrew D King, Juan Carrasquilla, Jack Raymond, Isil Ozfidan, Evgeny Andriyash, Andrew Berkley, Mauricio Reis, Trevor Lanting, Richard Harris, Fabio Altomare, et al. 2018. Observation of topological phenomena in a programmable lattice of 1,800 qubits. Nature 560, 7719 (2018), 456-460.
S. Kirkpatrick, C. D. Gelatt, and M. P. Vecchi. 1983. Optimization by Simulated Annealing. Science 220, 4598 (1983), 671-680. https://doi.org/10.1126/science.220.4598.671 arXiv: https://science.sciencemag.org/content/220/4598/671.full.pdf
Orion S. Lawlor, Sayantan Chakravorty, Terry L. Wilmarth, Nilesh Choudhury, Isaac Dooley, Gengbin Zheng, and Laxmikant V. Kale. 2006. ParFUM: A Parallel Framework for Unstructured Meshes for Scalable Dynamic Physics Applications. Eng. with Comput. 22, 3 (December 2006), 215-235.
Tao Lin, Sebastian U. Stich, and Martin Jaggi. 2018. Don't Use Large Mini-Batches, Use Local SGD. CoRR abs/1808.07217 (2018). arXiv: 1808.07217 http://arxiv.org/abs/1808.07217
Andrew Lucas. 2014. Ising formulations of many NP problems. Frontiers in Physics 2 (2014), 5.
Peter L. McMahon, Alireza Marandi, Yoshitaka Haribara, Ryan Hamerly, Carsten Langrock, Shuhei Tamate, Takahiro Inagaki, Hiroki Takesue, Shoko Utsunomiya, Kazuyuki Aihara, Robert L. Byer, M. M. Fejer, Hideo Mabuchi, and Yoshihisa Yamamoto. 2016. A fully programmable 100-spin coherent Ising machine with all-to-all connections. Science 354, 6312 (2016), 614-617. https://doi.org/10.1126/science. aah5178 arXiv: https://science.sciencemag.org/content/354/6312/614.full.pdf
Chris Mellor. 2021. DRAM, it stacks up: SK hynix rolls out 819 GB/s HBM3 tech. https://www.theregister.com/2021/10/20/sk_hynix_hbm3/
Misbah Mubarak, Seegyoung Seol, Qiukai Lu, and Mark S. Shephard. 1900. A Parallel Ghosting Algorithm for The Flexible Distributed Mesh Database. Scientific Programming 21 (1 Jan. 1900), 654971. https://doi.org/10.3233/SPR-130361
Saavan Patel, Lili Chen, Philip Canoza, and Sayeef Salahuddin. 2020. Ising Model Optimization Problems on a FPGA Accelerated Restricted Boltzmann Machine. arXiv: 2008.04436 [cs.AR]
D Pierangeli, G Marcucci, and C Conti. 2019. Large-scale photonic Ising machine by spatial light modulation. Physical review letters 122, 21 (2019), 213902.
Frank Seide, Hao Fu, Jasha Droppo, Gang Li, and Dong Yu. 2014. 1-Bit Stochastic Gradient Descent and Application to Data-Parallel Distributed Training of Speech DNNs. In Interspeech 2014 (interspeech 2014 ed.). https://www.microsoft.com/en-us/research/publication/1-bit-stochastic-gradient-descent-and-application-to-data-parallel-distributed-training-of-speech-dnns/
Sebastian U. Stich. 2019. Local SGD Converges Fast and Communicates Little. In International Conference on Learning Representations. https://openreview.net/forum?id=S1g2JnRcFX
Sebastian U. Stich, Jean-Baptiste Cordonnier, and Martin Jaggi. 2018. Sparsified SGD with Memory. In Proceedings of the 32nd International Conference on Neural Information Processing Systems (Montreal, Canada) (NIPS'18). Curran Associates Inc., Red Hook, NY, USA, 4452-4463.
Kenta Takata, Alireza Marandi, Ryan Hamerly, Yoshitaka Haribara, Daiki Maruo, Shuhei Tamate, Hiromasa Sakaguchi, Shoko Utsunomiya, and Yoshihisa Yamamoto. 2016. A 16-bit Coherent Ising Machine for One-Dimensional Ring and Cubic Graph Problems. Scientific Reports 6, 1 (2016), 34089. https://doi.org/10.1038/srep34089
Y Takeda, S Tamate, Y Yamamoto, H Takesue, T Inagaki, and S Utsunomiya. 2017. Boltzmann sampling for an XY model using a non-degenerate optical parametric oscillator network. Quantum Science and Technology 3, 1 (November 2017), 014004. https://doi.org/10.1088/2058-9565/aa923b
T. Takemoto, M. Hayashi, C. Yoshimura, and M. Yamaoka. 2019. 2.6 A 2 by 30 k-Spin Multichip Scalable Annealing Processor Based on a Processing-In-Memory Approach for Solving Large-Scale Combinatorial Optimization Problems. In IEEE International Solid-State Circuits Conference.
Kosuke Tatsumura, Alexander R. Dixon, and Hayato Goto. 2019. FPGA-Based Simulated Bifurcation Machine. In 2019 29th International Conference on Field Programmable Logic and Applications (FPL). 59-66. https://doi.org/10.1109/FPL. 2019.00019
Kosuke Tatsumura, Masaya Yamasaki, and Hayato Goto. 2021. Scaling out Ising machines using a multi-chip architecture for simulated bifurcation. Nature Electronics 4, 3 (1 Mar. 2021), 208-217. https://doi.org/10.1038/s41928-021-00546-4
Hongyi Wang, Scott Sievert, Zachary Charles, Shengchao Liu, Stephen Wright, and Dimitris Papailiopoulos. 2018. ATOMO: Communication-Efficient Learning via Atomic Sparsification. In Proceedings of the 32nd International Conference on Neural Information Processing Systems (Montréal, Canada) (NIPS′18). Curran Associates Inc., Red Hook, NY, USA, 9872-9883.
Tianshi Wang and Jaijeet Roychowdhury. 2019. OIM: Oscillator-Based Ising Machines for Solving Combinatorial Optimisation Problems. arXiv: 1903.07163 [cs.ET]
Tianshi Wang, Leon Wu, and Jaijeet Roychowdhury. 2019. New Computational Results and Hardware Prototypes for Oscillator-Based Ising Machines. In Proceedings of the 56th Annual Design Automation Conference 2019 (Las Vegas, NV, USA) (DAC '19). Association for Computing Machinery, New York, NY, USA, Article 239, 2 pages. https://doi.org/10.1145/3316781.3322473
Jianqiao Wangni, Jialei Wang, Ji Liu, and Tong Zhang. 2018. Gradient Sparsification for Communication-Efficient Distributed Optimization. In Advances in Neural Information Processing Systems, S. Bengio, H. Wallach, H. Larochelle, K. Grauman, N. Cesa-Bianchi, and R. Garnett (Eds.), Vol. 31. Curran Associates, Inc. https://proceedings.neurips.cc/paper/2018/file/3328bdf9a4b9504b9398284244fe97c2-Paper.pdf
Kasho Yamamoto, Kazushi Kawamura, Kota Ando, Normann Mertig, Takashi Takemoto, Masanao Yamaoka, Hiroshi Teramoto, Akira Sakai, Shinya Takamaeda-Yamazaki, and Masato Motomura. 2021. STATICA: A 512-Spin 0.25M-Weight Annealing Processor With an All-Spin-Updates-at-Once Architecture for Combinatorial Optimization With Complete Spin-Spin Interactions. IEEE Journal of Solid-State Circuits 56, 1 (2021), 165-178. https://doi.org/10.1109/JSSC.2020.3027702
Yoshihisa Yamamoto, Kazuyuki Aihara, Timothee Leleu, Ken-ichi Kawarabayashi, Satoshi Kako, Martin Fejer, Kyo Inoue, and Hiroki Takesue. 2017. Coherent Ising machines—Optical neural networks operating at the quantum limit. npj Quantum Information 3, 1 (2017), 1-15.
Masanao Yamaoka, Chihiro Yoshimura, Masato Hayashi, Takuya Okuyama, Hidetaka Aoki, and Hiroyuki Mizuno. 2015. A 20 k-spin Ising chip to solve combinatorial optimization problems with CMOS annealing. IEEE Journal of Solid-State Circuits 51, 1 (2015), 303-309.
M. Yamaoka, C. Yoshimura, M. Hayashi, T. Okuyama, H. Aoki, and H. Mizuno. 2015. 24.3 20 k-spin Ising chip for combinational optimization problem with CMOS annealing. In 2015 IEEE International Solid-State Circuits Conference—(ISSCC) Digest of Technical Papers. 1-3. https://doi.org/10.1109/ISSCC.2015.7063111
Chihiro Yoshimura, Masato Hayashi, Takuya Okuyama, and Masanao Yamaoka. 2017. Implementation and Evaluation of FPGA-based Annealing Processor for Ising Model by use of Resource Sharing. International Journal of Networking and Computing 7, 2 (2017), 154-172. http://www.ijnc.org/index.php/ijnc/article/view/148
G Zames, N M Ajlouni, N M Ajlouni, N M Ajlouni, J H Holland, W D Hills, and DE Goldberg. 1981. Genetic algorithms in search, optimization and machine learning. Information Technology Journal 3, 1 (1981), 301-302.
W. K. Hastings, Monte Carlo sampling methods using Markov chains and their applications, Biometrika, Volume 57, Issue 1, April 1970, Pages 97-109, https://doi.org/10.1093/biomet/57.1.97

What is claimed is:

1. A scalable Ising machine system, comprising:
a plurality of chips, each chip comprising:
a plurality of N nodes, each node comprising a capacitor, a positive terminal, and a negative terminal;
a plurality of N×M connection units, arranged in N rows and M columns, each connection unit comprising a set of reconfigurable resistive connections, each connection unit configurable to connect a pair of the N nodes via the reconfigurable resistive connections; and
a plurality of interconnects, wherein each chip of the plurality of chips is communicatively connected all other chips of the plurality of chips via at least one interconnect.

2. The scalable Ising machine system of claim 1, wherein the plurality of chips is arranged in a 2-dimensional array.

3. The scalable Ising machine system of claim 1, wherein the plurality of chips is arranged in a three-dimensional array.

4. The scalable Ising machine system of claim 1, wherein the plurality of chips is arranged in at least one square array.

5. The scalable Ising machine system of claim 1, wherein at least one interconnect of the plurality of interconnects comprises a wireless data connection.

6. The scalable Ising machine system of claim 1, wherein each chip further comprises a data buffer configured to store state information of at least a subset of the N nodes digitally.

7. The scalable Ising machine system of claim 1, wherein N=M.

8. The scalable Ising machine system of claim 1, wherein each connection unit comprises two positive terminals, each connected to the positive terminal of a different node in the plurality of nodes, and two negative terminals, each connected to the negative terminal of a different node of the plurality of nodes.

9. The scalable Ising machine system of claim 1, wherein at least one interconnect of the plurality of interconnects comprises a switch configured to connect or disconnect the interconnect.

10. The scalable Ising machine system of claim 1, wherein at least one chip further comprises a reconfigurable connection fabric for connecting the nodes.

11. The scalable Ising machine system of claim 1, each chip further comprising a buffer memory, a processor, and a non-transitory computer-readable medium with instructions stored thereon, which when executed by the processor stores node states in the buffer memory and retrieves node states from the buffer memory.

12. The scalable Ising machine system of claim 1, wherein the instructions further comprise the steps of sequentially transmitting node states from one chip to the next in order to execute a larger task in batch mode.

13. The scalable Ising machine system of claim 1, wherein each buffer memory is sufficient to store a buffered copy of at least a subset of the states in the scalable Ising machine system.

14. The scalable Ising machine system of claim 1, wherein each buffer memory is sufficient to store a buffered copy of all the states in the scalable Ising machine system.

15. A method of calculating a Hamiltonian of a system of coupled spins, comprising:
providing a scalable Ising machine system comprising a plurality of chips, each chip comprising:
a plurality of N nodes, each node comprising a capacitor, a positive terminal, and a negative terminal, the charge on the capacitor representing a spin; and
a plurality of N×M connection units, arranged in N rows and M columns, each connection unit comprising a set of reconfigurable resistive connections, each connection unit configurable to connect a pair of the N nodes via the reconfigurable resistive connections; and
connecting the plurality of chips to one another via a set of interconnects;
segmenting the system of coupled spins into a set of sub-systems, and configuring each chip of the plurality of chips with a subsystem of the set of sub-systems; and
calculating the Hamiltonian of the system of coupled spins by calculating all the sub-systems.

16. The method of claim 15, comprising calculating the sub-systems at least partially sequentially.

17. The method of claim 15, comprising calculating the sub-systems simultaneously.

18. The method of claim 15, further comprising storing states of at least a subset of the nodes in a buffer memory.

19. The method of claim 15, further comprising transmitting a subset of node states from one chip to another.

20. The method of claim 15, further comprising storing states of all the nodes in a buffer memory on each chip of the plurality of chips.
